(19) United States
(12) Patent Application Publication
(10) Pub. No.: US 2026/0204044 A1
(43) Pub. Date: Jul. 16, 2026

(54) METHOD AND SYSTEM OF AUTOMATED SEDIMENTARY STRUCTURE DETECTION USING OBJECT DETECTION AND TRANSFER LEARNING

(71) Applicants: KING FAHD UNIVERSITY OF PETROLEUM AND MINERALS, Dhahran (SA); SAUDI DATA AND ARTIFICIAL INTELLIGENCE AUTHORITY (SDAIA), Riyadh (SA)

(72) Inventors: Korhan AYRANCI, Dhahran (SA); Umair Bin WAHEED, Dhahran (SA)

(73) Assignees: KING FAHD UNIVERSITY OF PETROLEUM AND MINERALS, Dhahran (SA); SAUDI DATA AND ARTIFICIAL INTELLIGENCE AUTHORITY (SDAIA), Riyadh (SA)

(21) Appl. No.: 19/021,043

(22) Filed: Jan. 14, 2025

(51) Int. Cl. G06V 10/764; E21B 25/00; G06V 10/25; G06V 10/26; G06V 10/77; G06V 10/774; G06V 10/82

(52) U.S. Cl. CPC G06V 10/764; E21B 25/00; G06V 10/25; G06V 10/26; G06V 10/7715; G06V 10/774; G06V 10/82

(57) ABSTRACT

A method for automated sedimentary structure recognition includes acquiring a digital image of a siliciclastic sedimentary rock in a drilling core. The method further includes processing the digital image by segmenting the digital image into a grid of image cells. Once the digital image is segmented into the grid, extracting image features from the grid, using a backbone Convolutional Neural Network (CNN). Upon extracting the image features, predicting multiple bounding boxes per grid cell using a CNN object detection model. Each bounding box has a confidence score that reflects a likelihood of an object's presence and a precision of a bounding box. Further, coordinates of each bounding box, class labels of objects in each bounding box, and the confidence score for each bounding box as an output to a user.

### STATEMENT OF ACKNOWLEDGEMENT

Support provided by Saudi Data and AI Authority (SDAIA) and King Fahd University of Petroleum and Minerals (KFUPM) under SDAIA-KFUPM Joint Research Center for Artificial Intelligence Grant no. JRC-AI-RG-03 is gratefully acknowledged.

### BACKGROUND

### Technical Field

The present disclosure is directed to Artificial Intelligence (AI), more particularly to a method and a system for automated sedimentary structure recognition.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Geosciences rely heavily on the visual analysis of rock features from sources such as outcrops, thin sections, cores, and scanning electron microscopy images to understand subsurface reservoir characteristics. Among these methods, core-based analysis is particularly crucial for facies analysis, which involves evaluating parameters like lithology, mineralogy, sedimentary structures, bioturbation, and fossil content. Of these, sedimentary structures offer valuable insights into sediment transport processes, helping distinguish between fluvial and marine environments, identifying depositional energy conditions, and understanding processes like turbidity currents. These structures are directly linked to reservoir properties, as the hydrodynamic conditions that shape them significantly affect porosity and permeability.

Determining sedimentary structures and their vertical variations is crucial for understanding paleoenvironments. Sedimentary successions reflect highly dynamic environments, with their deposits exhibiting both vertical and horizontal variability. For instance, the Amazon Basin presently receives sandy deposits with diverse sedimentary structures due to its extensive delta. When sea levels rise, these sandy sediments will be overlain by deep-water muddy sediments, characterized by entirely different sedimentary structures. Consequently, vertical variations in sedimentary structures within the rock record (e.g., cores or outcrops) provide valuable insights into paleoenvironmental changes. Since cores and outcrops can be significantly thick, these vertical changes help to better understand the historical development of basin fill over time. This approach, known as facies analysis, is widely used in sedimentology.

Traditional methods for identifying sedimentary structures in core samples rely on visual observation by geoscientists that specialize in sedimentary structures. While effective, these methods are time-consuming and prone to human error and bias, leading to inconsistencies. This manual approach demands significant expertise and effort. Consequently, there is a growing need for automated techniques that can accelerate the identification of sedimentary structures, reduce human bias, and enhance consistency. Transitioning from manual to automated techniques marks a major advancement in geological research. While traditional manual methods provide detailed analysis, they are often slow and labor-intensive. In contrast, automation techniques offer faster, and potentially more precise analysis, improving efficiency and enabling rapid processing of large datasets. This shift can potentially facilitate more accurate and reliable geological interpretations and represents a crucial step toward integrating advanced technologies into routine geological workflows.

Machine learning is one such automation technique that has achieved much attention. The majority of machine learning applications in geology, especially those involving core-based research, depend predominantly on wireline logs. Currently, there are almost no efforts directed at identifying sedimentary structures using core samples.

One promising machine learning technology for automating geological analysis is the Convolutional Neural Network (CNN), a type of Artificial Neural Network (ANN) designed to process image and video data. CNNs have demonstrated significant success in computer vision tasks such as image classification and object detection. In geology, CNNs have been applied to tasks like core-based lithofacies identification and bioturbation intensity analysis. However, most research has focused on lithology and texture. Research has avoided sedimentary structure identification due to its complex nature. One advancement in CNN applications is the Mask Region-Based Convolutional Neural Network (Mask-RCNN), designed for semantic segmentation and classification tasks. Still, while Mask-RCNN has significantly improved lithofacies identification, its primary focus on texture and lithology does not address problems in sedimentary structure identification.

Object detection involves detection of locations of objects using bounding boxes and assigns confidence scores to predictions. Object detection techniques have the potential to perform geological feature identification and analysis, making them valuable for core analysis. These techniques are being applied to automate the identification of geological formations and features from images. However, these techniques have not been applied to identification of sedimentary structures as sedimentary structures have their own unique challenges.

The most common sedimentary rocks, such as sandstone, shale, and conglomerate, are formed from siliciclastic sediments. Siliciclastic sediments are silica-based sediments, lacking carbon compounds, which are formed from pre-existing rocks, by breakage, transportation and redeposition to form sedimentary rock. Siliciclastic rocks are composed primarily of silicate materials, such as quartz or clay minerals. Siliciclastic rock types include mudrock, sandstone, and conglomerate.

Siliciclastic rocks are highly variable in grain size and contrast. In particular, siliciclastic formations exhibit a wide range of grain sizes, compositions, and often lower contrast between sedimentary structures and their background. This makes certain features (e.g., mud drapes, small-scale laminations) very difficult to detect using conventional object detection techniques. Also, siliciclastic formations generally present a broader array of sedimentary structures (e.g., cross bedding, hummocky cross stratification) compared to carbonates, requiring the model to detect multiple features of differing scales and geometries. For example, in siliciclastic formations, it is more common to see frequent vertical variations in sedimentary structures.

Accordingly, it is one object of the present disclosure to provide a method and a system for automated sedimentary structure recognition using a CNN. A further object is a machine learning model to detect multiple features of differing scales and geometries.

### SUMMARY

In an exemplary embodiment, a method for automated sedimentary structure recognition is described. The method includes acquiring, by a mobile device, a digital image of a siliciclastic sedimentary rock in a drilling core. The method includes processing, by a processing circuitry of the mobile device, the digital image by segmenting the digital image into a grid of image cells. The method includes extracting from the grid, using a backbone Convolutional Neural Network (CNN), image features. The method includes predicting, by a CNN object detection model, multiple bounding boxes per grid cell, each bounding box having a confidence score that reflects a likelihood of an object's presence and a precision of a bounding box. The precision of the bounding box is a percentage of the bounding box that is a correct prediction. The method includes outputting coordinates of each bounding box, class labels of objects in each bounding box, and the confidence score for each bounding box.

In another exemplary embodiment, a system for automated sedimentary structure recognition is described. The system includes a mobile device configured to acquire a digital image of a siliciclastic sedimentary rock in a drilling core. The mobile device is configured to process the digital image by segmenting the digital image into a grid of image cells. The mobile device is configured to extract image features from the grid using a backbone Convolution Neural Network (CNN). The mobile device is configured to predict, by a CNN object detection model, multiple bounding boxes per image cell, each bounding box having a confidence score that reflects a likelihood of an object's presence and a precision of a bounding box. The precision of the bounding box is a percentage of the bounding box that is a correct prediction. The mobile device is configured to output coordinates of each bounding box, class labels of objects in each bounding box, and the confidence score for each bounding box.

In another exemplary embodiment, a non-transitory computer readable medium having instructions stored therein that, when executed by one or more processor, cause the one or more processors to perform a method of automated sedimentary structure recognition is described. The method includes acquiring, by a mobile device, a digital image of a siliciclastic sedimentary rock in a drilling core. The method includes processing, by a processing circuitry of the mobile device, the digital image by segmenting the digital image into a grid of image cells. The method includes extracting from the grid, using a backbone Convolutional Neural Network (CNN), image features. The method includes predicting, by a CNN object detection model, multiple bounding boxes per grid cell, each bounding box having a confidence score that reflects a likelihood of an object's presence and a precision of a bounding box. The precision of the bounding box is a percentage of the bounding box that is a correct prediction. The method includes outputting coordinates of each bounding box, class labels of objects in each bounding box, and the confidence score for each bounding box.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary diagram of a system configured for automated sedimentary structure recognition, according to certain embodiments.

FIG. 2 illustrates an exemplary diagram representing a drilling rig, according to certain embodiments.

FIG. 3 illustrates an exemplary diagram depicting results of an augmentation technique applied to core images present in training data, according to certain embodiments.

FIG. 4 illustrates an exemplary diagram depicting an architecture of a Convolution Neural Network (CNN), according to certain embodiments.

FIG. 5A-FIG. 5B illustrate an exemplary diagram representing results of analysis performed by the CNN on an image of core box sedimentary structures, according to certain embodiments.

FIG. 6A-FIG. 6B illustrates another exemplary diagram representing results of analysis performed by the CNN on an image of the core box with varied sedimentary structures, according to certain embodiments.

FIG. 7A-FIG. 7C illustrates an exemplary diagram representing results of analysis performed by the CNN on an image of the core box containing wide range of sedimentary structures, according to certain embodiments.

FIG. 8A-FIG. 8D illustrates another exemplary diagram representing results of analysis performed by the CNN on an image of the core box containing wide range of sedimentary structures, according to certain embodiments.

FIG. 9A-FIG. 9E illustrates yet another exemplary diagram representing results of analysis performed by the CNN on an image of the core box containing wide range of sedimentary structures, according to certain embodiments.

FIG. 10A-FIG. 10E illustrates an exemplary diagram representing results of analysis performed by the CNN on an image of the core box before performing transfer learning and after performing transfer learning, according to certain embodiments.

FIG. 11 illustrates an exemplary diagram of a method for automated sedimentary structure recognition, according to certain embodiments.

FIG. 12 is an exemplary illustration of a non-limiting example of a mobile device, according to certain embodiments.

FIG. 13 is a block diagram illustrating an example computer system for implementing machine learning training and inference methods according to certain embodiments.

FIG. 14 is an illustration of a non-limiting example of details of computing hardware used in a computing device, according to certain embodiments.

FIG. 15 is an exemplary schematic diagram of a data processing system used within the computing device, according to certain embodiments.

FIG. 16 is an exemplary schematic diagram of a processor used with the computing device, according to certain embodiments.

FIG. 17 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and a method for automated sedimentary structure recognition is disclosed. The method includes acquiring a digital image of a siliciclastic sedimentary rock in a drilling core. Upon acquiring the digital image, the digital image is processed to segment the digital image into a grid of image cells. Once the digital image is segmented into the grid, image features are extracted from the grid using a backbone Convolutional Neural Network (CNN). Upon extracting the image features, multiple bounding boxes are predicted per grid cell using a CNN object detection model. In an embodiment, each bounding box has a confidence score that reflects a likelihood of an object's presence and a precision of a bounding box. Further, coordinates of each bounding box, class labels of objects in each bounding box, and the confidence score for each bounding box are provided as an output to a user.

Certain sedimentary structures in siliciclastic rocks, such as ripples or fine laminations, are relatively small and subtle having very similar features to its background compared to larger formations. To address this, a conventional CNN object detection model has been modified. Modifications include segmenting images into a grid of reduced images area to accommodate a wider array of bounding box sizes, and expanding the model to include deeper network layers in order to optimize detection for small-scale features in the context of complex backgrounds.

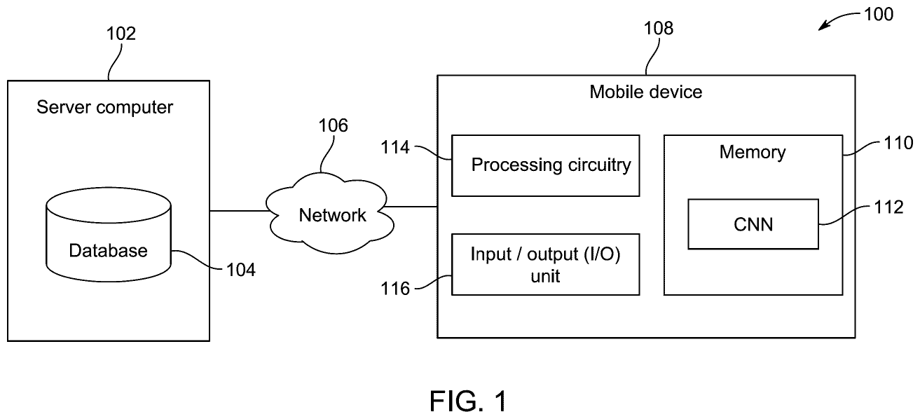

Referring now to FIG. 1, the present disclosure provides an exemplary diagram of a system 100 configured for automated sedimentary structure recognition, according to certain embodiments. In particular, in order to perform the sedimentary structure recognition, the system 100 includes a mobile device 108. Examples of the mobile device 108 may include, but are not limited to, a smartphone, a laptop, a desktop, a tablet, a wearable device, and a handheld field computer. In order to perform the sedimentary structure recognition, initially, drilling is performed into a subterranean geologic formation to obtain a drilling core. The subterranean geologic formation refers to a layer or a structure of a rock, a sediment, or mineral deposits located beneath the earth's surface. These subterranean geologic formations can include a variety of geological features such as aquifers, oil reservoirs, or ore deposits.

Once the drilling core is obtained, the mobile device 106 may be configured to acquire a digital image of a siliciclastic sedimentary rock in the drilling core. In an embodiment, the mobile device 108 may acquire the digital image via an inbuilt camera (not shown). In some embodiments, the mobile device 108 may receive the digital image from a camera remotely located at the drilling core via a network 106. The siliciclastic sedimentary rock is a type of sedimentary rock composed primarily of fragments (clasts) of silicate minerals, such as quartz, feldspar, or rock fragments, that have been weathered and deposited by water or wind. Examples of the siliciclastic sedimentary rock include a sandstone, a shale, a conglomerate, and a breccia. Further, a drilling core refers to a cylindrical sample of rock or sediment extracted from the ground using a drilling rig, typically to study a composition, a structure, and properties of subsurface materials, such as those encountered in geological or resource exploration. Further, to accurately distinguish structural features of the siliciclastic sedimentary rock, the mobile device 108 uses a cross-bedding angle threshold to differentiate between different types of stratified structures, where the stratified structures are layers of strata. The structural features of the siliciclastic sedimentary rocks are the various patterns and structures that form within these siliciclastic sedimentary rocks due to depositional processes, compaction, and diagenesis. Further, the cross-bedding angle threshold may be defined by a user (e.g., a geologist, a field technician, a data scientist, and the like) based on geological context and a specific type of sedimentary structure being analyzed. For example, the cross-bedding angle threshold might be set to greater than 20° to identify dunes or higher-energy environments, and less than 20° for lower-energy, more stable depositional settings.

Once the digital image is acquired, the processing circuitry 114 of the mobile device 108 may be configured to process the digital image. The processing of the digital image includes segmenting the digital image into a grid of image cells. Once the digital image is segmented into the grid of image cells, image features are extracted using a backbone CNN, e.g., a portion of CNN 112. The CNN 112 may reside within a memory 110 for execution by the mobile device 108. The image features may include edges, textures, shapes, patterns, etc. In an embodiment, apart from the backbone CNN, other similar techniques may be used to extract the image features either individually or in conjunction with the backbone CNN. Examples of the other similar techniques may include, but are not limited to, a Scale-Invariant Feature Transform (SIFT), a Histogram of Oriented Gradients (HOG), a Speeded-Up Robust Features (SURF), edge detection filters, and autoencoders.

Upon extracting the image features, the mobile device 108 is configured to predict multiple bounding boxes per grid cell using a CNN object detection model, e.g., another portion of the CNN 112. In an embodiment, each bounding box has a confidence score that reflects a likelihood of an object's presence and a precision of a bounding box. The precision of the bounding box is a percentage of the bounding box that is a correct prediction. In other words, each bounding box is assigned the confidence score, which indicates the likelihood of the object being present, and the precision, which measures how accurately the bounding box predicts the object's location relative to the true object. In an embodiment, the confidence score may be predicted using a softmax function. Further, the confidence score may be between ‘0’ to ‘100’, indicating an accuracy of an object present within the bounding box. Once the multiple bounding boxes are predicted, the mobile device 108 is configured to output coordinates of each bounding box, class labels of the objects in each bounding box, and the confidence score for each bounding box using an Input/Output (I/O) unit 116. In other words, the coordinates of each bounding box, the class labels of the objects in each bounding box, and the confidence score for each bounding box may be displayed to the user using the I/O unit 116.

The core images are prone to surface imperfections, drill marks, pen marks and shadows, which can interfere with object detection. In an embodiment, noise-handling techniques incorporate custom filters to reduce the impact of such artifacts. In an embodiment, to mitigate noise and artifacts, Gaussian and median filters are applied to smooth textures and eliminate high-frequency noise. Brightness and contrast adjustments can also be made across the dataset, and data augmentation techniques further enhance model robustness by simulating variations in image quality and lighting conditions.

In an embodiment, the CNN 112 may be trained to perform the automatic sedimentary structure recognition using a server computer 102. Examples of the server computer 102 may include, a laptop, a desktop, a tablet, a phablet, and the like, configured to perform machine learning tasks. The server computer 102 may train the CNN 112 by augmenting original training data, including core images of siliciclastic sedimentary rocks to expand object bounding boxes threefold by applying adjustments to brightness, exposure, and blur. In particular, the server computer 102 is configured to train the CNN 112 using a set of core images that depict the siliciclastic sedimentary rocks. The set of core images is used as the training data to train the CNN 112 to detect the objects (e.g., geological features) within each of the set of core images. Examples of the geological features may include cross-bedding, ripple marks, fossils, bioturbation, mud cracks, and the like. In order to train the CNN 112 based on the training data, an augmentation technique (also referred to as the augmentation) is applied to each core image. The augmentation includes adjustments to brightness, exposure, and blur of each image in the training data to create modified versions of original core images present in the training data. The augmentation expands the object's bounding boxes threefold, which means the CNN object detection model will learn to recognize the objects in different lighting conditions, exposures, and blur levels, making it more robust to real-world variations in image quality.

Once each image in the training dataset is augmented, one of the core images is segmented into the grid of image cells. This segmentation helps the CNN 112 to focus on smaller regions of a core image for object detection. Upon segmenting, the image features are extracted from the grid using the backbone CNN. The image features are extracted at a variety of different scales. In an embodiment, the backbone CNN and the CNN object detection model may be different. In some embodiments, the backbone CNN and the CNN object detection model may each correspond to the CNN 112. In other words, each image cell in the grid is analyzed using the backbone CNN (which may be an initial set of layers of the CNN 112) to extract meaningful image features like the edges, the textures, the shapes, and the patterns that help identify the objects. Further, the extraction of the image features happens at the variety of different scales means that the CNN 112 is configured analyze the core image at different resolutions or levels of detail (e.g., fine details in smaller scales and broader features in larger scales). This enables the CNN 112 to detect the objects of different sizes and complexities within the core image.

In an embodiment, during training of the CNN 112, the server computer 102 may be configured to perform transfer learning. The transfer learning utilizes weights from the CNN object detection model (e.g., the CNN 112) applied to a collection of annotated images obtained from various initial datasets and fine-tunes the CNN object detection model using annotated images from a second dataset. The annotated images refer to images that have been labeled or marked with metadata that provides information about specific features or objects within each image. The second dataset includes box core images that present a fluvial, a shoreface, and a delta deposition with various lithologies (i.e., physical and chemical characteristics of the siliciclastic sedimentary rocks). Further, the transfer learning includes fine-tuning the CNN object detection model using the annotated images from the box core images that present the fluvial, the shoreface, and the delta deposition with the various lithologies.

During the training of the CNN object detection model, the server computer 102 uses multiple classes for different sedimentary structures and three background classes. The multiple classes may include, for example, mud drapes, a massive sandstone, a bioturbated muddy media, massive mudstone, and the like. Further, the three background classes may include, broken pieces, an empty, and a scale bar. The initial datasets and the second dataset may be stored in a database 104 of the server computer 102. Further, the database 104 may be periodically updated with new annotated images associated with one or more pre-trained CNN object detection models.

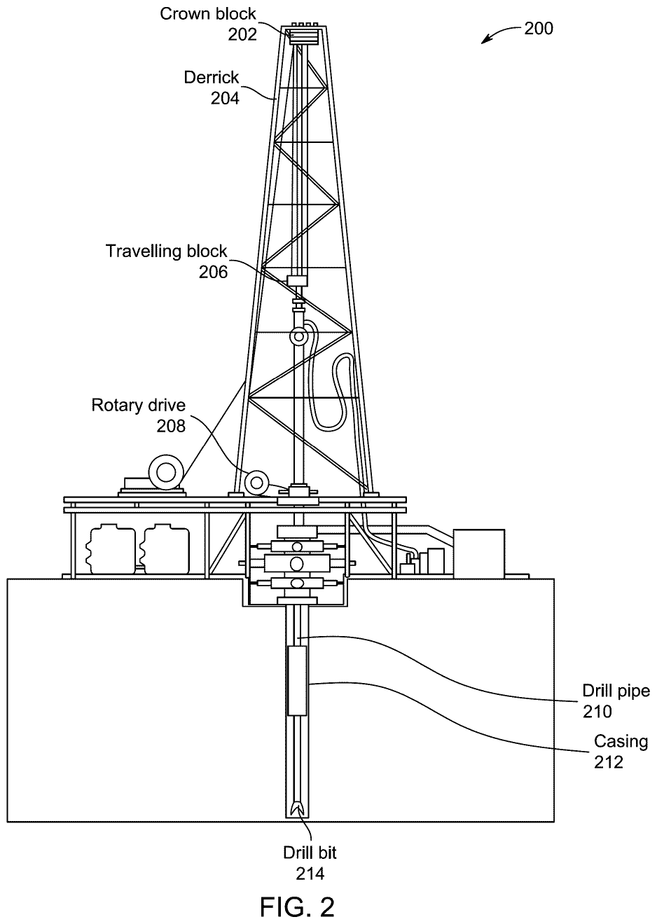

In an embodiment, in order to train the CNN object detection model using data with unbalanced classes, the server computer 102 excludes classes with fewer than a predetermined number of bounding boxes, with an exception of a fissile shale class. In other words, the server computer 102 may exclude classes from the training dataset that have fewer than the predetermined number of bounding boxes (e.g., 50 bounding boxes). The fissile shale class is an exception. Even if the fissile shale class has fewer bounding boxes than the predetermined number of bounding boxes (i.e., 50 bounding boxes) it is not excluded from the training data. Further, the server computer 102 applies a Non-Maximum Suppression (NMS) to filter out overlapping bounding boxes and retaining those non-overlapping bounding boxes with a highest confidence score. This complete method of performing the automatic sedimentary structure recognition is further explained in detail in conjunction with FIG. 2 to FIG. 11.

The memory 110 may be a volatile memory, such as a Random-Access Memory (RAM), or a non-volatile memory such as a Read Only Memory (ROM), an Erasable Programmable Read Only Memory (EPROM), a flash memory, and the like. The memory 110 may be configured to store one or more computer-readable instructions or routines that when executed may cause the mobile device 108 to perform the automatic sedimentary structure recognition. The memory 110 may perform the sedimentary structure recognition in conjunction with the processing circuitry 114. In other words, the processing circuitry 114 may be configured to execute the one or more computer-readable instructions stored within the memory 114 to perform the sedimentary structure recognition. The processing circuitry 114 may be implemented as one or more microprocessors, microcomputers, microcontrollers, Digital Signal Processors (DSPs), Central Processing Units (CPUs), logic circuitries, and/or any devices that process data based on operational instructions.

In an embodiment, the mobile device 108 may also include an Input/Output (I/O) unit 116. The I/O unit 116 may be used by the user to provide inputs (such as the digital image, a value of the cross-bedding angle threshold, the training data, a value of the predetermined number of bounding boxes, and the like) to the mobile device 108. Further, the I/O unit 116 may be used to display results, e.g., the multiple bounding boxes predicted per grid cell, the coordinates of each bounding box, the class labels of the objects in each bounding box, and the confidence score for each bounding box, etc., based on processing performed by the mobile device 108 for the sedimentary structure recognition.

Referring now to FIG. 2, the present disclosure illustrates an exemplary diagram representing a drilling rig 200, according to certain embodiments. The drilling rig 200 corresponds to a large machine used for drilling holes into the earth's surface to extract resources such as oil, gas, water, or minerals. The drilling rig 200 is commonly used in industries like petroleum, natural gas, mining, and geothermal energy. The drilling rig 200 is designed to create a hole (or a borehole) by rotating a drill bit into the ground. In current context, the drilling rig 200 is used to drill into the earth's surface to extract core samples of sedimentary rock layers. These core samples, often referred to as core samples or drilling cores, provide critical geological information about a composition, a structure, and a history of sedimentary layers beneath the earth's surface. The drilling rig 200 includes a crown block 202, a derrick 204, a travelling block 206, a rotary drive 208, a drill pipe 210, a casing 212, and a drill bit 214. The crown block 202 is located at a top of the drilling rig 200. The crown block 202 consists of a set of pulleys or sheaves that guide a drill line (a cable or rope) to lift and lower a drill string and other heavy equipment, such as the drill pipe 210.

The derrick 204 (also referred to as a mast in some drilling rigs) is a tall, vertical structure that supports and raises the drill string (or the dill pipe 210 used to drill the hole on the earth's surface). The derrick 204 allows workers to change drill bits and add new sections of the drill pipe 210 as drilling progresses. The travelling block 206 is a large block of metal that moves vertically along the derrick 204 to raise and lower the drill string. The large block and a tackle system of pulleys and ropes are used to lift heavy equipment, including the drill pipe 210. The rotary drive 208 in the drilling rig 200 provides a rotational force (torque) necessary to turn the drill bit 214 and penetrate the earth's surface during the drilling process. The rotary drive 208 transmits mechanical power to rotate the drill string, which in turn rotates the drill bit 214. This rotational movement allows the drill bit to cut through rock formations and create the drilling core. The drill pipe 210 is a long section of a steel pipe that connects the surface equipment (e.g., mud tanks, mud pumps, blowout preventors, etc.) to the drill bit 214 in the drilling rig 200. The drill pipe 210 is used to transmit drilling fluids and to provide the necessary torque to rotate the drill bit 214.

Further, the casing 212 is a steel pipe that is inserted into a drilled wellbore to stabilize a well and prevent surrounding rocks or soil from collapsing. The casing 212 is placed between the drill pipe 210 and the drill bit 214 during the drilling process, providing structural support to the well and enabling a safe circulation of drilling fluids. The casing 212 also helps to isolate different geological formations and protect freshwater aquifers from contamination. Further, the drill bit 214 is a cutting tool at an end of the drill pipe 210, which grinds through rock and soil. The drill bit 214 is typically made of hard materials like diamond or tungsten carbide to handle tough geological formations.

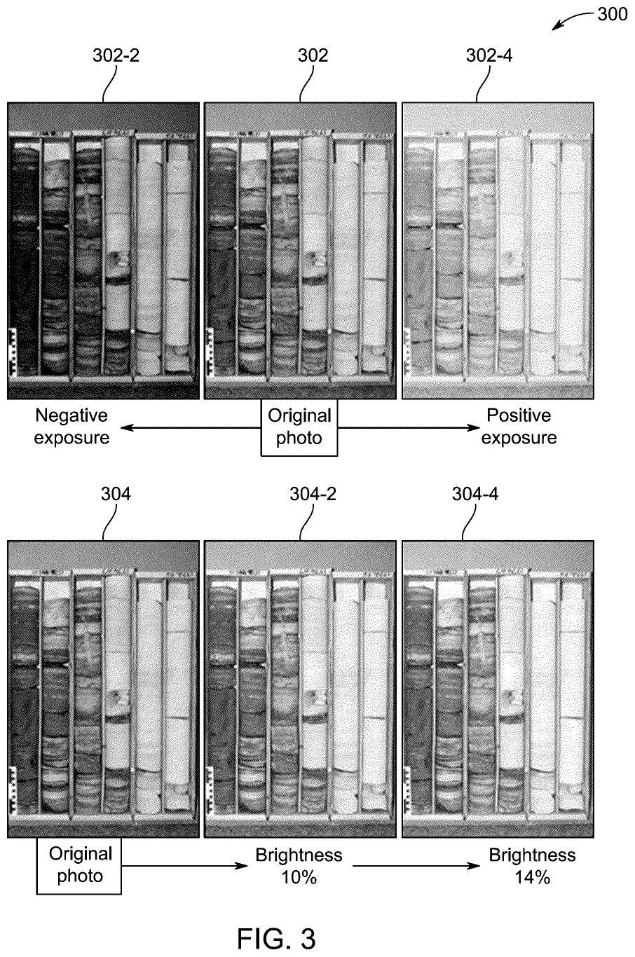

Referring now to FIG. 3, the present disclosure provides an exemplary diagram 300 depicting results of the augmentation technique applied to core images present in the training data, according to certain embodiments. As depicted in the FIG. 3, two core images, e.g., an original image 302 and an original image 304 is shown. In an embodiment, the augmentation technique is applied to each core image to adjust brightness, exposure, and blur of each core image to create modified versions of these original images, i.e., the original image 302 and the original image 304.

As depicted in present FIG. 3, the modified versions of the original image 302 include an image 302-2 and an image 302-4. Similarly, the modified version of the original image 304 includes an image 304-2 and an image 304-4. The augmentation technique applied to the original image 302 includes negative and positive exposures. The negative and positive exposures involve adjusting exposure levels of the original image 302. The negative exposure involves decreasing an exposure level of the original image 302, resulting in the generation of the image 302-2 with reduced brightness and contrast, simulating a darker or underexposed scene, often resulting in more shadowed details. Further, the positive exposure includes increasing the exposure level of the original image 302, resulting in the generation of the image 302-4 with higher brightness and contrast, simulating an overexposed scene with more illuminated or washed-out areas. In an embodiment, the negative and positive exposures may be applied to each core image present in the training data to simulate different lighting conditions or camera settings which help the CNN object detection model to become more robust to variations in lighting and contrast.

The augmentation technique applied to the original image 304 includes a brightness augmentation. As depicted in the FIG. 3, a random increase in brightness, such as between 10% to 14%. The brightness augmentation applied to the original image 304 with 10% results in the generation of the image 304-2. Further, the brightness augmentation applied to the original image 304 with 14% results in the generation of the image 304-4. The augmentation techniques applied to each core image in the training data enhance the CNN object detection model's ability to recognize the objects under different illumination conditions, helping the CNN object detection model to adapt to scenes that may appear lighter or darker in real-world scenarios. Further, these augmentation techniques allow the CNN object detection model to learn more diverse features, leading to better performance when processing new, unseen images.

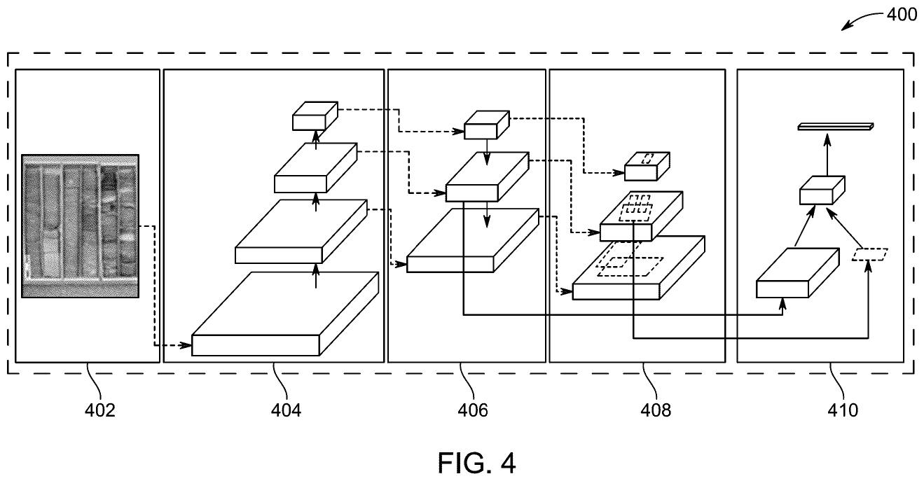

Referring now to FIG. 4, the present disclosure provides an exemplary diagram 400 depicting an architecture of a CNN (e.g., the CNN 112), according to certain embodiments. The CNN 112 may correspond to the CNN object detection model. For example, the CNN object detection model may correspond to a You Look Only Once (YOLO) version 4, i.e., the YOLOv4.

In a preferred embodiment, the YOLOv4 architecture is enhanced by resizing anchor boxes to better capture smaller features and by introducing deeper convolutional layers to refine feature extraction at multiple scales. Three additional convolutional layers are introduced at the 64×64, 128×128, and 256×256 scales to increase the model's ability to extract features at multiple resolutions. The image grid is divided into smaller segments, increasing the detection accuracy for small sedimentary structures. These modifications effectively improve the model's sensitivity to subtle features such as mud drapes and faint bioturbated textures.

Initially, at step 402, an image (e.g., the core image or the digital image in real-time) is received as an input by the mobile device 108. Upon receiving the input image, the input image is segmented into the grid of the image cells. Further, at step 404, the image features are extracted from the grid using the backbone CNN, i.e., a Darknet in the YOLOv4. The Darknet is a neural network architecture that serves as a backbone for the YOLOv4. The Darknet is primarily responsible for the image feature extraction, which means the Darknet identifies and processes relevant image features (such as the edges, the textures, the patterns, etc.) from the input image. These image features are then used to locate and classify the objects in the input image. In particular, the Darknet performs a task of extracting high-level features of the input image, which are then passed on to the CNN object detection model for further processing.

Further, at step 406, a neck component is used to perform the image features aggregation. The neck aggregates multi-scale image features to ensure that the CNN object detection model can detect the objects of varying sizes. This is particularly important in object detection tasks where small and large objects need to be detected simultaneously. The neck helps in refining feature maps produced by the backbone CNN, i.e., the Darknet by applying techniques like a Feature Pyramid Network (FPN) or a Path Aggregation Network (PAN). The FPN generates feature pyramids from different layers in the backbone CNN, helping the CNN object detection model to detect the objects across different scales. Further, the PAN refines the process of the image features aggregation by focusing on both low-level and high-level image features, improving the performance of the CNN object detection model for detecting the objects at different scales.

Once the image feature aggregation is performed, at step 408, the bounding boxes and the class labels are predicted for the objects within the input image. In particular, the CNN object detection model, i.e., the YOLOv4 uses a two-stage prediction process to detect and classify the objects in the input image. A first task in the YOLOv4 is regression, which focuses on predicting the bounding boxes around the objects in the input image. A bounding box is a rectangular box that tightly encloses an object, providing its position in the input image. Further, a second task of the YOLOv4's prediction process is classification, which assigns a class label to the object inside the bounding box. The class label identifies the object (e.g., the mud drapes, the massive sandstone, the massive mudstone, etc.) within the bounding box. Further, each bounding box is assigned the confidence score representing the likelihood of the object's presence and the precision of the bounding box. Once the bounding boxes and the class labels are predicted, at step 410, a sparse prediction is performed for the objects within the input image. The sparse prediction is performed to focus on making predictions only in regions of the input image where the objects are likely to be present, rather than generating predictions for every grid cell in the input image. This approach of using the sparse prediction reduces the number of false positives and makes the CNN object detection model computationally more efficient.

In an embodiment, to train the CNN for identifying the sedimentary structures, two datasets were utilized. The two datasets included 500 box core images of siliciclastic sedimentary rocks. A first data set (also referred to as a dataset 1, an initial dataset) is composed of 400 box core images (also referred to as core box images or core images) presenting various depositional settings (e.g., estuary, shoreface, offshore, and delta), lithology (e.g., mudstone, sandstone, and conglomerate), and formations (e.g., Viking Formation). These core images have an average resolution of, for example, 2129×2969 pixels. A second dataset (also referred to as a dataset 2) is an open access data (ExxonMobil-SEPM Core Data-EPR Price River A and EPR Price River C lower) composed of 100 box core images presenting the fluvial, the shoreface, and the delta deposition with various lithologies. An average resolution of the core images in the second dataset is, for example, 3715×4700 pixels. The dataset 1 and the dataset 2 in combination is referred to as the training dataset.

In an embodiment, the dataset 1 is used as a main dataset. All images in the dataset 1 are used for labelling sedimentary structures, training the CNN 112, validating the CNN 112, and for performing blind testing. A total of 19 class labels may be used to represent 16 different sedimentary structures (i.e., the plurality of classes) and 3 labels are used for background elements (i.e., the three background classes) such as scale bars, as detailed in a Table 1.

TABLE 1

| | | Number of | | Number of | |
|---|---|---|---|---|---|
| | | bounding boxes | | bounding boxes | |
| | | (before | | (after | |
| | Class | augmentation) | | augmentation) | |
| Sedimentary | Mud drapes | 7,802 | 22.2% | 21,357 | 24.8% |
| structures | Massive | 5,899 | 16.8% | 12,396 | 14.4% |
| | sandstone | | | | |
| | Bioturbated | 4,698 | 13.4% | 11,900 | 13.8% |
| | muddy media | | | | |
| | Massive | 3,392 | 9.7% | 8,797 | 10.2% |
| | mudstone | | | | |
| | Bioturbated | 2,895 | 8.2% | 9,509 | 11.0% |
| | sandy media | | | | |
| | Parallel | 1,908 | 5.4% | 3,794 | 4.4% |
| | lamination | | | | |
| | Low-angle | 1,477 | 4.2% | 2,835 | 3.3% |
| | lamination | | | | |
| | Massive | 1,193 | 3.4% | 2,493 | 2.9% |
| | conglomerate | | | | |
| | Cross-bedding | 779 | 2.2% | 1,671 | 1.9% |
| | Current ripple | 236 | 0.7% | 594 | 0.7% |
| | Fissile shale | 148 | 0.4% | 375 | 0.4% |
| | Rip-up clast | 100 | 0.3% | 237 | 0.3% |
| | Scattered | 84 | 0.2% | 186 | 0.2% |
| | pebble | | | | |
| | Concretion | 48 | 0.1% | 135 | 0.2% |
| | Soft sediment | 41 | 0.1% | 108 | 0.1% |
| | deformation | | | | |
| | Wavy bedding | 8 | 0.02% | 30 | 0.03% |
| Background | Broken pieces | 2,610 | 7.4% | 5,920 | 6.9% |
| classes | Empty | 1301 | 3.7% | 2,856 | 3.3% |
| | Scale bar | 484 | 1.4% | 1,004 | 1.2% |

| | | |
|---|---|---|
| Total: | 35,103 | 86,197 |

As depicted in the Table 1, each row of a first column, i.e., class, provides a name of the multiple classes for the different sedimentary structures along with the three background classes. Further, a second column, i.e., a number of bounding boxes before augmentation is divided into two sub-columns. Each row of a first sub-column of the second column represents a number of bounding boxes of a corresponding class. Further, each row of a second sub-column of the second column represents a percentage of a total bounding boxes in the training data before augmentation. Further, a third column, i.e., a number of bounding boxes after augmentation is divided into two sub-columns. Each row of a first sub-column of the third column represents a number of bounding boxes of a corresponding class. Further, each row of a second sub-column of the third column represents a percentage of a total bounding boxes in the training data after augmentation. For example, the “mud drapes” class initially has 7,802 bounding boxes, which represents 22.2% of the total bounding boxes in the training data before augmentation. After applying the augmentation technique, the number of bounding boxes for the “mud drapes” class increases to 21,357, which now accounts for 24.8% of the total bounding boxes. This indicates that the augmentation technique significantly increases a number of samples for the “mud drapes” class, improving its representation in the training data. In particular, the Table 1 shows the number of bounding boxes for each sedimentary structure class before and after image augmentation. After augmentation, the total number of bounding boxes increases from 35,103 to 86,197, with certain classes, such as “mud drapes” and “massive sandstone,” experiencing significant increases in bounding box count, while others, like “parallel lamination” and “wavy bedding,” have relatively smaller changes.

The dataset 2 is mainly used for cross-validation and transfer learning. Of the 100 images in the dataset 2, 20 are labeled and trained for the transfer learning, while the remaining 80 are utilized to test and evaluate the performance of the CNN 112. Overall, 16 classes, including 13 sedimentary structures classes (i.e., the multiple classes) and the three background classes, are used to label the core images in the dataset 2. Box core images (i.e., the core images) from the dataset 2 are taken from siliciclastic sedimentary successions similar to those in the dataset 1. Therefore, 13 sedimentary structure classes in the dataset 2 are identical to the most commonly represented sedimentary structure classes in the dataset 1.

Further, the core images from the dataset 1 may be labeled with bounding box annotations using a Roboflow online platform, which offers various pre-processing and augmentation options. The augmentation technique aids in increasing the training data, thereby improving the CNN 112 performance and enhancing the robustness of the CNN 112. In particular, the augmentation expands the original training data threefold (resulting in 1200 core box images) by applying adjustments to the brightness, the exposure, and the blur. Both the brightness and the exposure adjustments help ensure the CNN 112 flexibility and resistance to variations in camera settings. This application of blur augmentation assists the CNN 112 in adapting to changes in camera focus settings.

In an embodiment, the YOLOv4 architecture with the Darknet framework may be utilized due to its real-time object detection capabilities that effectively balance accuracy and processing speed. The YOLOv4 architecture with the Darknet framework is ideal for both feature extraction and object detection, making it adept at identifying small to medium-sized objects. Further, the YOLOv4 is customized and trained on the training data, with a focus on maximizing accuracy. The CNN 112 performance is assessed using five metrics, i.e., an accuracy, a precision, a recall, an F1-score, and the IoU. The Accuracy is a metric that is used to assess the overall performance of a classification model, i.e., the CNN 112. The accuracy measures the proportion of correctly classified instances out of the total number of predictions in the training data. The accuracy is calculated using an equation 1.

$$Accuracy = \frac{T P + T N}{T P + T N + F P + F N} , \qquad ( 1 )$$

In the equation 1, ‘TP’ represents true positive instances where the CNN 112 correctly identified as a specific sedimentary structure. ‘TN’ represents true negatives where the CNN 112 correctly identifies that a sedimentary structure is not of a certain type. ‘FP’ stands for false positive where the CNN 112 incorrectly identifies a sedimentary structure. Further, ‘FN’ signifies false negative where the CNN 112 misses an identification of a sedimentary structure.

The precision is a metric that measures the accuracy of positive predictions, specifically focusing on the proportion of correctly identified positive instances among all positive predictions. The precision is calculated using an equation 2.

$$Precision = \frac{T P}{T P + F P} \qquad ( 2 )$$

In the equation 2, ‘TP’ represents the true positives and ‘FP’ represents the false positives.

The recall, also known as true positive rate or sensitivity, quantifies the CNN 112 ability to capture all the positive instances in the training data. The recall is calculated using an equation 3.

$$Recall = \frac{T P}{T P + F N} \qquad ( 3 )$$

In the equation 3, ‘TP’ represents the true positives and ‘FN’ represents the false negatives.

The F1-score is a combined metric that balances recall and precision. The F1-score is a harmonic mean of the precision and the recall. The F1-score is particularly valuable in situations where there exists an imbalance between positive and negative classes. The F1-score is calculated using an equation 4.

$$F 1 - score = \frac{2 * ( Precision * Recall )}{Precision + Recall} \qquad ( 4 )$$

The IoU is a metric utilized to estimate the overlap between predicted and ground truth bounding boxes. The IoU serves as a reliable indicator for evaluating the accuracy of object detection models. An IoU threshold of 50% is assigned to decide whether the prediction is true or false.

A table 2 below represents values of the five metrices calculated based on the performance of the CNN 112. Each row of a first column, i.e., parameters, represents a name of each metric. Further, each row of a second column, i.e., percentages (%) represents a value of each metric calculated based on the performance of the CNN 112. For example, the mean average precision for the CNN 112 is determined to be 92.8% which indicates that the CNN 112 is able to accurately identify and localize the objects within the core images present in the training data.

TABLE 2

| Parameter | Percentages (%) |
|---|---|
| Mean Average Precision | 92.8 |
| Recall | 93 |
| F1-Score | 93 |
| Intersection over Union | 80.8 |

Further, a Table 3 represents a mean average precision of each individual class of sedimentary structures identified by the CNN 112. Each row of a first column, i.e., class, represent the name of each of the multiple classes, i.e., sedimentary structures and three background classes. Further, each row of a second column, i.e., average precision, represents a value of a mean average precision for a corresponding class. For example, a mean average precision for the mud drapes class, i.e., 0.845 (or 84.5%), represents a moderate level of accuracy of the CNN 112 for detecting the mud drapes class.

TABLE 3

| | Class | 0.845 |
|---|---|---|
| Sedimentary | Mud drapes | 0.964 |
| structures | Massive sandstone | 0.916 |
| | Bioturbated muddy media | 0.964 |
| | Massive mudstone | 0.954 |
| | Bioturbated sandy media | 0.96 |
| | Parallel lamination | 0.968 |
| | Low-angle lamination | 0.994 |
| | Massive conglomerate | 0.988 |
| | Cross-bedding | 0.826 |
| | Current ripple | 0.988 |
| | Fissile shale | 0.821 |
| | Rip-up clast | 0.303 |
| | Scattered pebble | 0.944 |
| | Concretion | 1 |
| | Soft sediment deformation | 1 |
| | Wavy bedding | 0.964 |
| Background | Broken pieces | 0.989 |
| classes | Empty | 0.926 |
| | Scale bar | 0.845 |

In particular, as depicted via the Table 3, among the sedimentary structures with high representation (i.e., over 10,000 examples), the massive sandstone exhibits the highest mean average precision at 0.964, i.e., 96.4%. Further, the mud drapes, despite being the most abundantly represented sedimentary structure, achieve the mean average precision of 84.5% due to their similar appearance to other structures, such as a thinly bedded mudstone and a bioturbated muddy media. The sedimentary structures with more than 1,000 training examples demonstrate notably high average precisions, particularly a massive conglomerate and a cross-bedding, with 99.4% and 98.8% average precision, respectively. Therefore, considering their frequent appearance in validation and test images, it can be inferred that these sedimentary structure classes outperform other studied sedimentary structures.

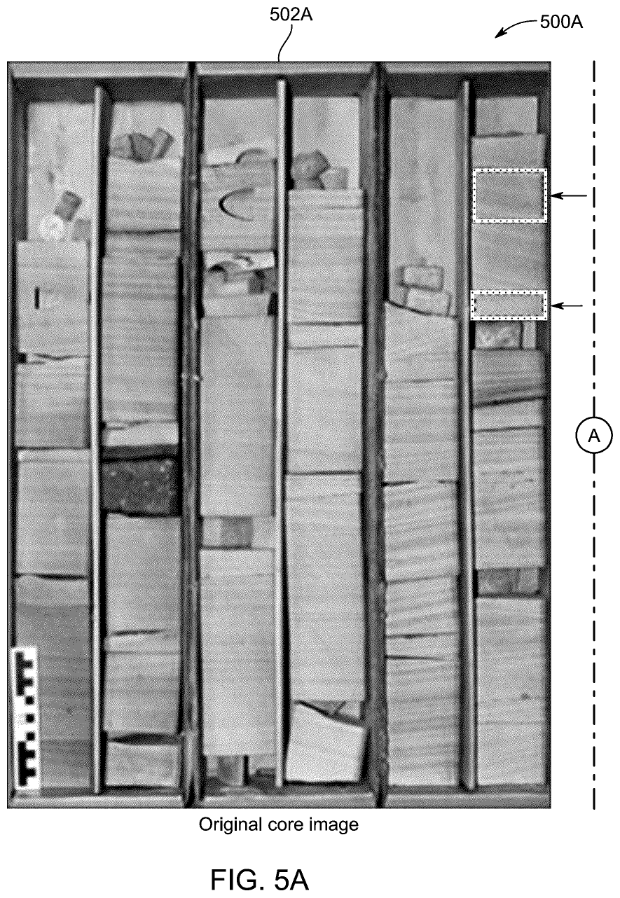

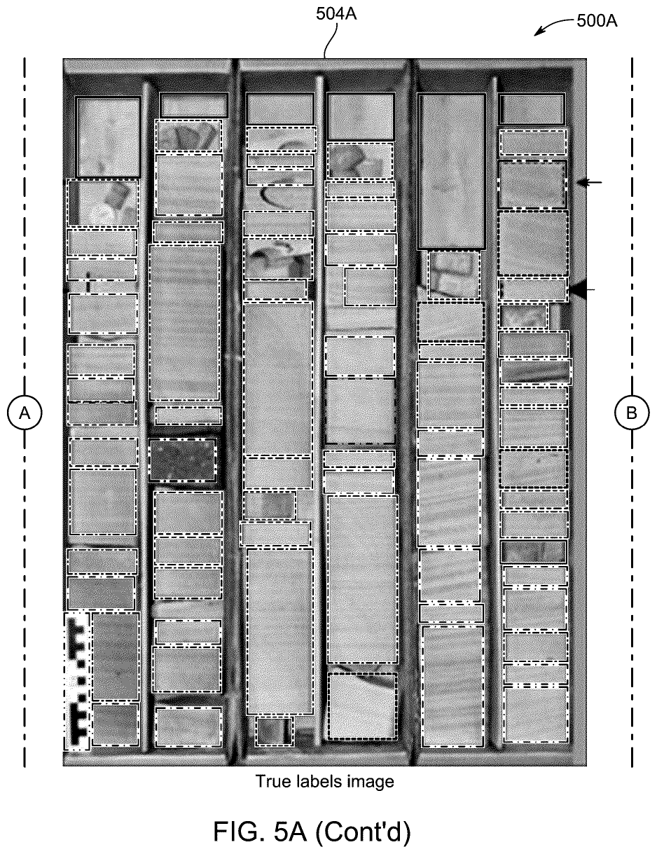

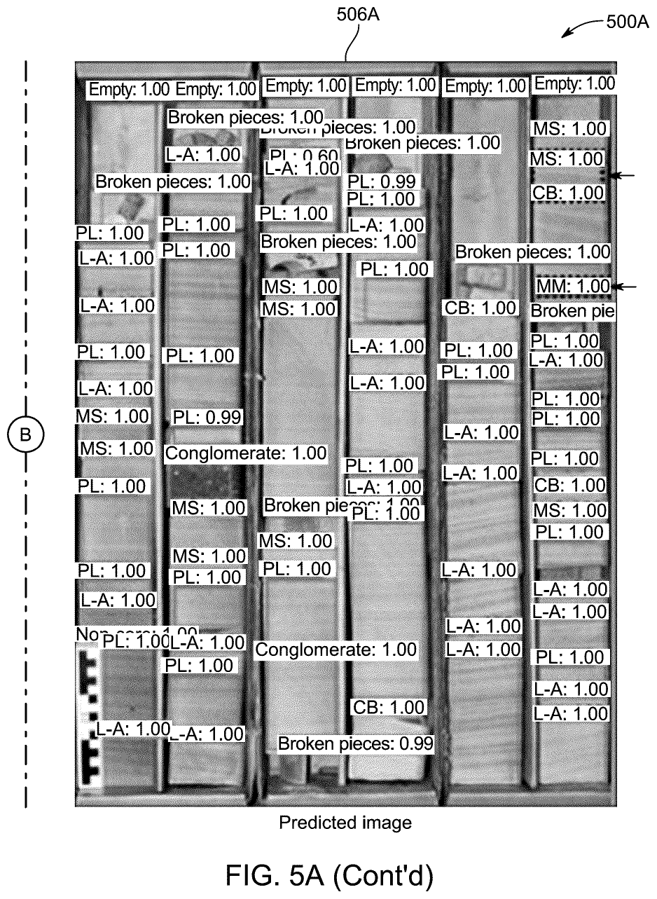

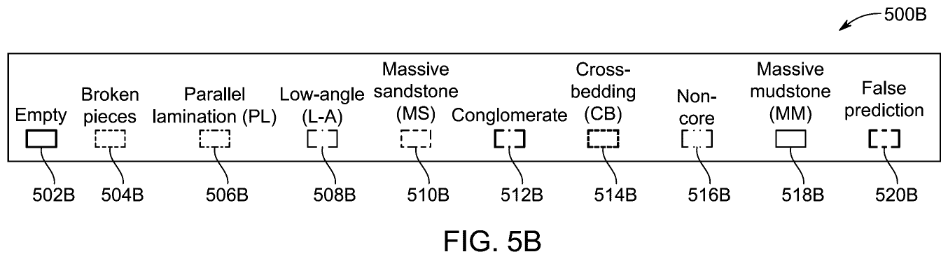

FIGS. 5A and 5B, illustrate results of analysis performed by the CNN (i.e., the CNN 112) on an image of a core box sedimentary structure, according to certain embodiments. In particular, once the CNN 112 is trained, the performance of the CNN 112 is analyzed by providing the image of the core box sedimentary structure (also referred to as a box core image) as an input to the CNN 112. In an embodiment, the core box in the context of sedimentary structures refers to a container or a storage unit that holds geological core samples extracted during drilling operations. The image of the core box sedimentary structure may correspond to an original core image 502A as depicted via a pictorial depiction 500A in FIG. 5A. The original core image 502A is provided as an input to the CNN, i.e., the CNN 112. The CNN 112 may correspond to each of the backbone CNN and the CNN object detection model. For example, the CNN 112 may be the YOLOv4.

In addition to the original core image 502A, the user provides an annotated image, i.e., a true labels image 504A to the CNN 112. The true labels image 504A is also referred to as a ground truth image. The true labels image 504A is used by the user (e.g., the geologist) to determine how well the CNN 112 is performing. In particular, to generate the true labels image 504A the geologist annotates the original core image 502A with accurate bounding boxes, class labels, and sometimes confidence score. As depicted in the FIG. 5A, in the true labels image 504A, each class label is represented by a bounding box using a different type of line. A class label annotated in the true labels image 504A includes multiple class labels as depicted via FIG. 5B. Further, based on processing performed by the CNN 112 on the original core image 502A, a predicted image 506A is generated. As depicted in the FIG. 5A, the predicted image 506A may include, the bounding boxes, the class labels, and the confidence score associated with the objects within the original core image 502A. In particular, based on the processing performed by the CNN 112 on the original core image 502A, the bounding boxes and the class labels are assigned around the detected objects (such as a sandstone, a mudstone, a cross-bedding).

Further, the CNN 112 assigns the confidence score to each prediction of the bounding box and the class label. The confidence score reflects the CNN 112 certainty about an accuracy of the bounding box and the class label. Further, as depicted in the FIG. 5A, at maximum instances, the CNN 112 can predict accurate bounding boxes and class labels. However, at two instances marked using an arrow, the CNN 112 incorrectly identifies a massive sandstone as a massive mudstone and misclassifies a low-angle cross-bedding as a massive sandstone. In other words, the predictions from the CNN 112, i.e., the YOLOv4 align closely with the actual classifications, as depicted the original core image 502A and the true labels image 504A in FIG. 5A. Further, as depicted via the true labels image 504A and the predicted image 506A, the CNN 112 exhibits maximum confidence score in identifying the low-angle cross-bedding and the massive sandstone, both at 100%. In an embodiment, a high-angle cross-bedding predictions generally hold a confidence score of 99% to 100%. Further, as depicted in the predicted image 506A, while most predictions for the parallel lamination fall within the 99% to 100% confidence score range, one prediction stands at 60% confidence score.

Further, the FIG. 5B illustrates legends 500B, i.e., the class labels that the CNN 112 is configured to detect within the original input image 502A. As depicted in the FIG. 5B, the class labels annotated in the true labels image 504A and predicted by the CNN 112 as depicted via the predicted image 506A may include an empty 502B, a broken pieces 504B, a parallel lamination 506B, a low angle 508B, a massive sandstone 510B, a conglomerate 512B, a cross bedding 514B, a non-core 516B, a massive mudstone 518B, and a false prediction 520B.

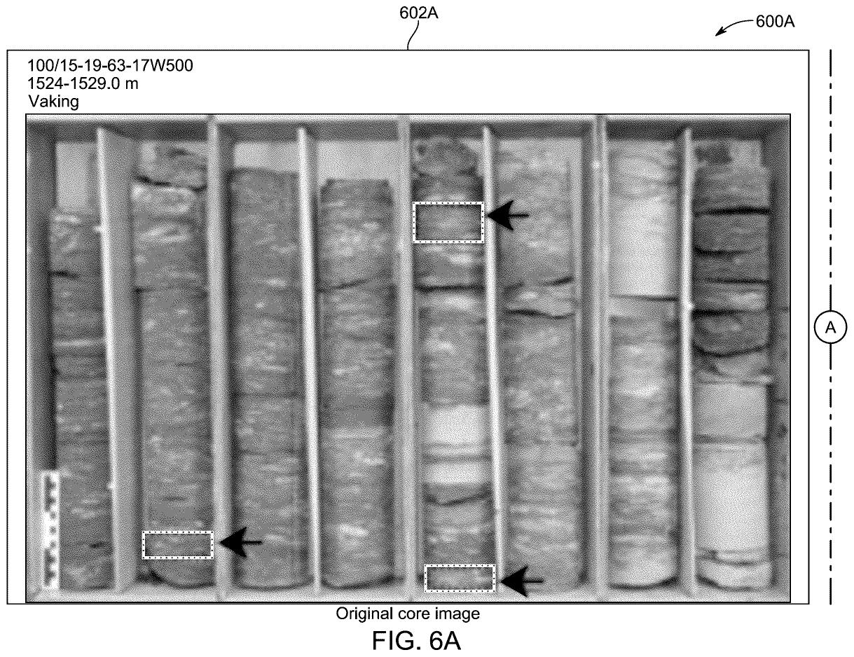

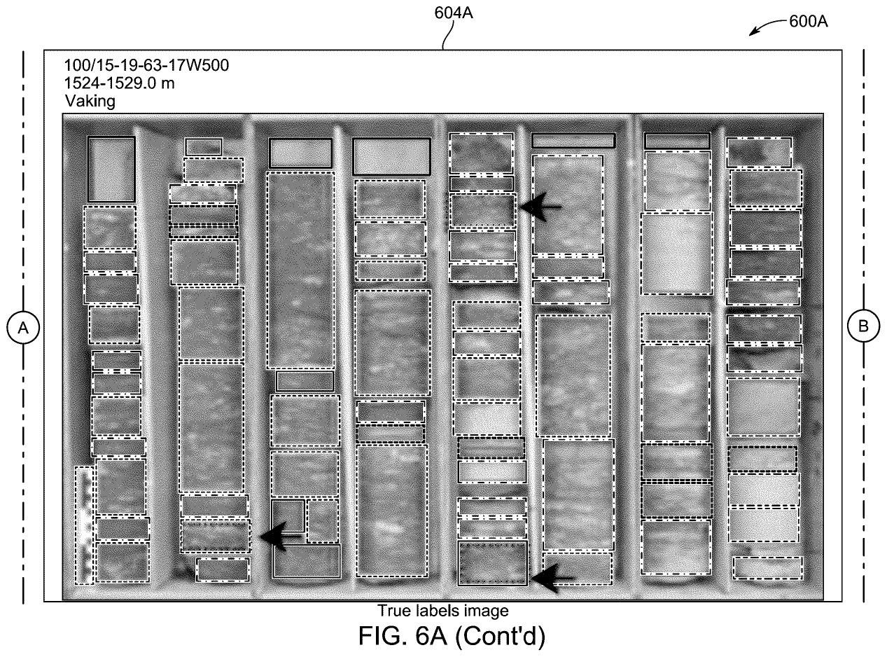

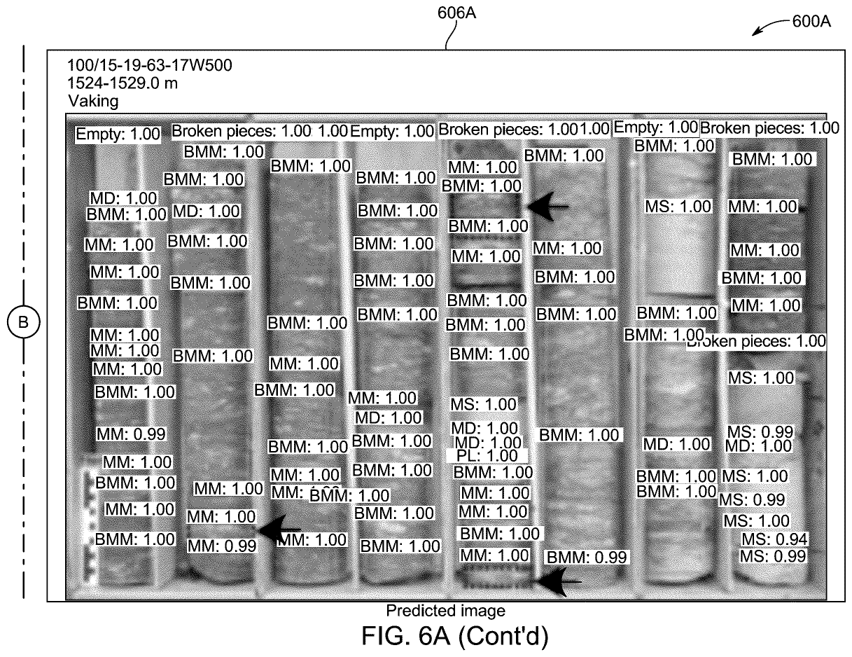

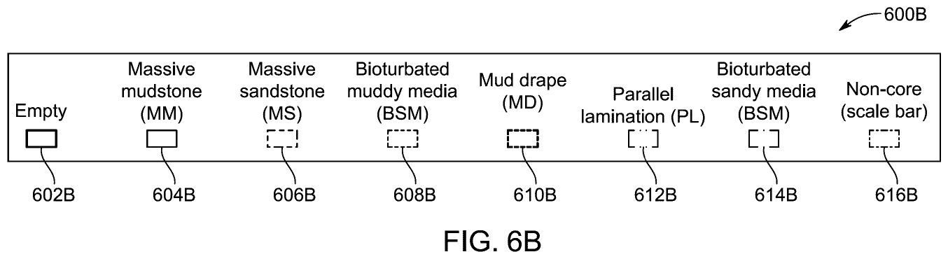

FIGS. 6A and 6B illustrates results of analysis performed by the CNN (i.e., the CNN 112) on an image of the core box with varied sedimentary structures, according to certain embodiments. A pictorial depiction 600A of FIG. 6A represents an original core image 602A, a true labels image 604A, and a predicted image 606A. The original core image 602A is provided as an input to the CNN, i.e., the CNN 112. The CNN 112 may correspond to the backbone CNN and the CNN object detection model. For example, the CNN 112 may be the YOLOv4.

In addition to the original core image 602A, the user provides an annotated image, i.e., the true labels image 604A to the CNN 112. The true labels image 604A is also referred to as a ground truth image. The true labels image 604A is used by the user (e.g., the geologist) to determine how well the CNN 112 is performing. In particular, to generate the true labels image 604A, the geologist annotates the original core image 602A with accurate bounding boxes, class labels, and sometimes confidence scores. As depicted in the FIG. 6A, in the true labels image 604A, each class label is represented by a bounding box using a different type of line. A class label annotated in the true labels image 604A includes multiple class labels as depicted via FIG. 6B. Further, based on processing performed by the CNN 112 on the original core image 602A, the predicted image 606A is generated. As depicted in the FIG. 6A, the predicted image 606A may include, the bounding boxes, the class labels, and the confidence score associated with the objects within the original core image 602A. In particular, based on the processing performed by the CNN 112 on the original core image 602A, the bounding boxes and the class labels (such as a bioturbated sandy media and a bioturbated muddy media) are assigned around the detected objects.

Further, the CNN 112 assigns the confidence score to each prediction of the bounding box and the class label. The confidence score reflects the CNN 112 certainty about an accuracy of the bounding box and the class label. Further, as depicted in the FIG. 6A, at maximum instances, the CNN 112 predicted accurate bounding boxes and class labels. However, at two instances marked using an arrow, the CNN 112 misclassified the bioturbated sandy media as the bioturbated muddy media, which are similar in appearance but different in geological properties. In particular, as depicted via the predicted image 606A, predictions for the massive mudstone consistently display a confidence score of 100%, except for two instances at 99%. Further, the predictions for the massive sandstone vary in the confidence score, ranging from 94% to 100%. Furthermore, the confidence scores for the mud drape ranges from 85% to 100%.

Further, the FIG. 6B illustrates legends 600B, i.e., the class labels that the CNN 112 can detect within the original input image 602A. As depicted in the FIG. 6B, the class labels annotated in the true labels image 604A and predicted by the CNN 112 as depicted via the predicted image 606A may include an empty 602B, a massive mudstone 604B, a massive sandstone 606B, a bioturbated muddy media 608B, a mud drapes 610B, a parallel lamination 612B, a bioturbated sandy media 614B, and a non-core (scale bar) 616B.

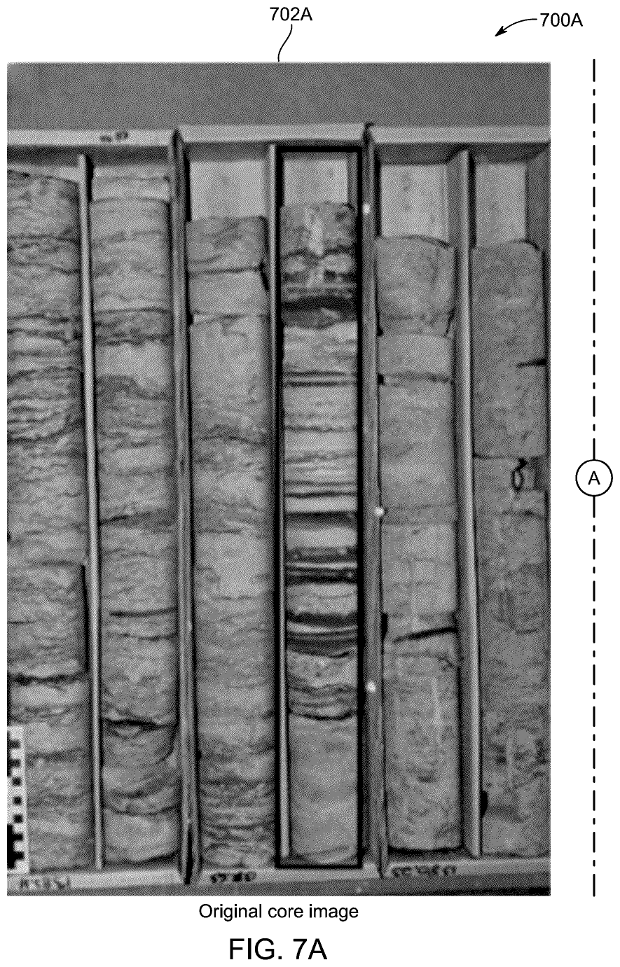

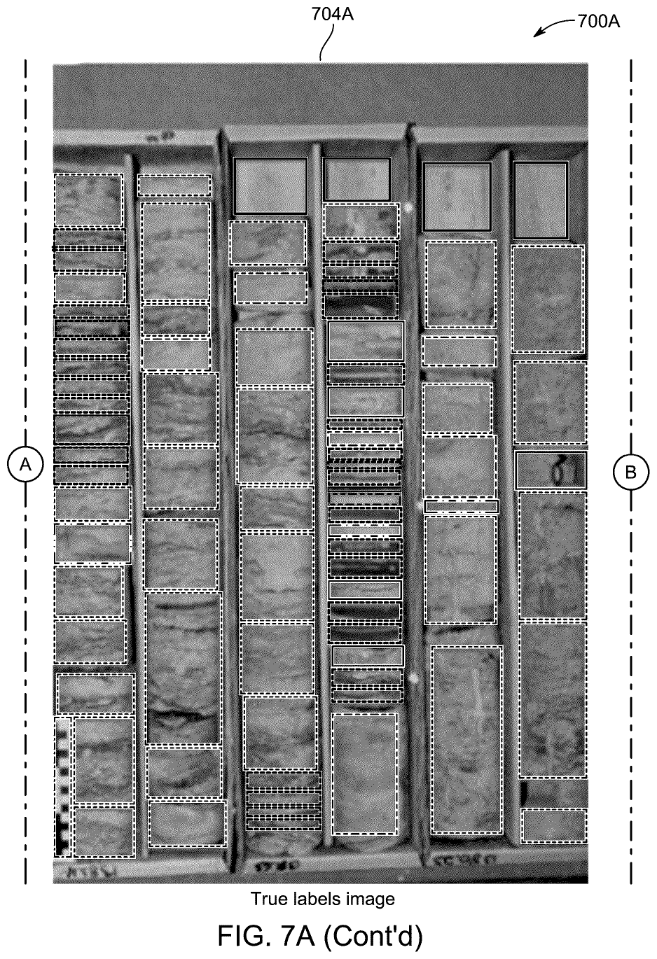

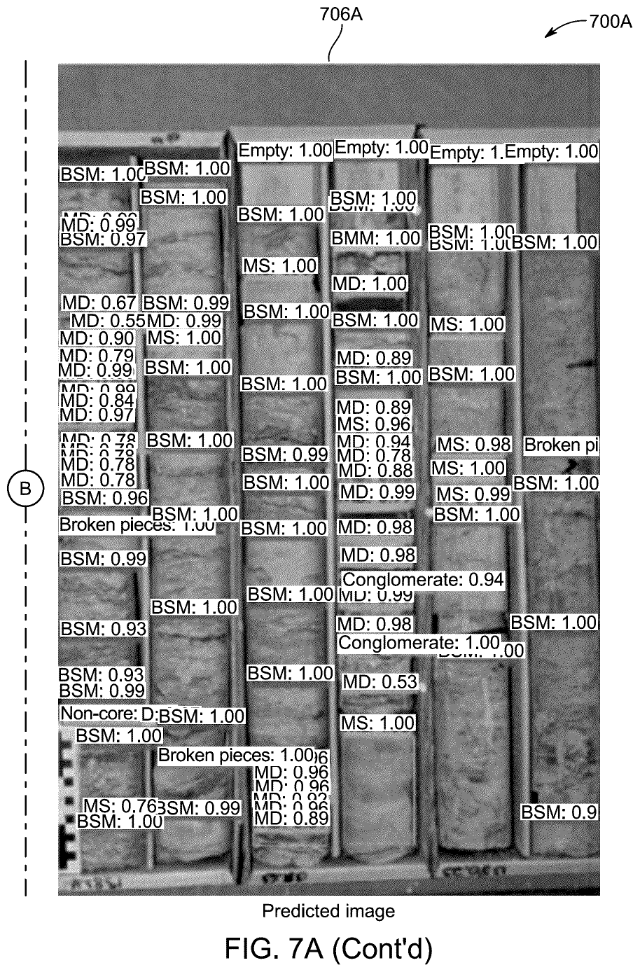

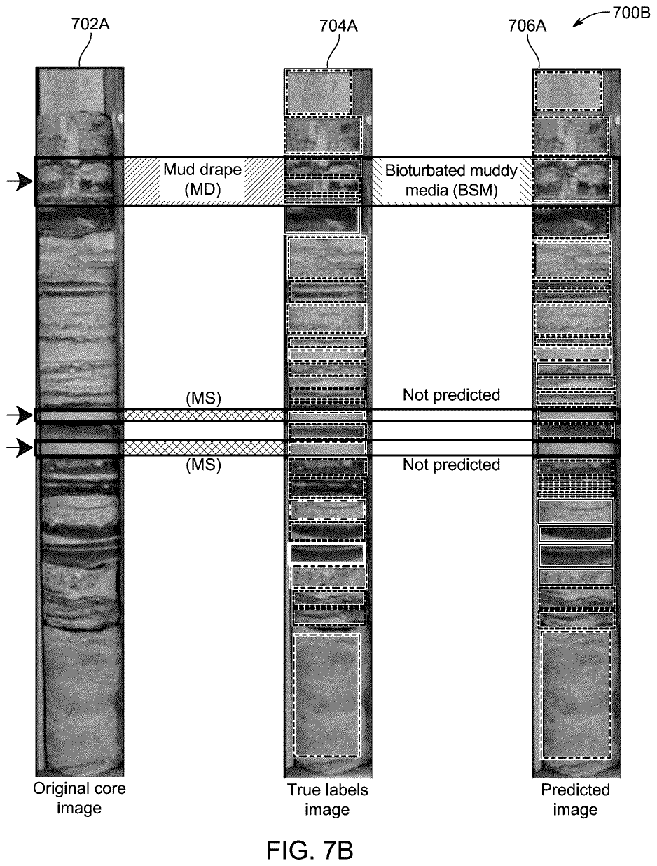

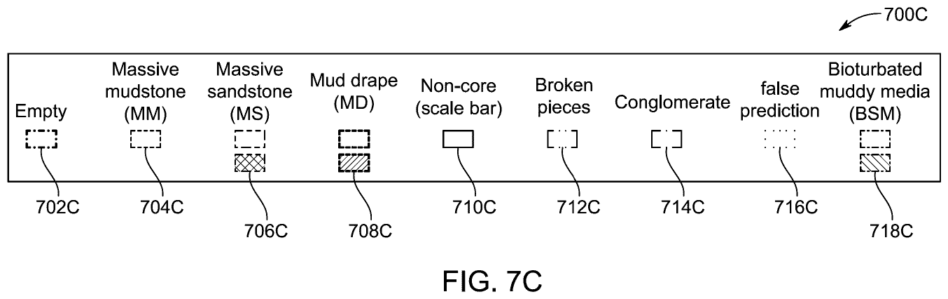

Referring now to FIGS. 7A-7C, the present disclosure provides an exemplary diagram illustrating results of analysis performed by the CNN (i.e., the CNN 112) on an image of the core box containing wide range of sedimentary structures, according to certain embodiments. A pictorial depiction 700A of FIG. 7A illustrates an original core image 702A, a true labels image 704A, and a predicted image 706A. The original core image 602A is provided as an input to the CNN, i.e., the CNN 112. In addition to the original core image 602A, the user provides an annotated image, i.e., the true labels image 704A to the CNN 112. The true labels image 704A is also referred to as the ground truth image. In particular, to generate the true labels image 704A, the user (e.g., the geologist) annotates the original core image 702A with accurate bounding boxes, class labels, and sometimes confidence scores. As depicted in the FIG. 7A, in the true labels image 704A, each class label is represented by a bounding box using a different type of line. A class label annotated in the true labels image 704A includes multiple class labels as depicted via FIG. 7C. Further, based on processing performed by the CNN 112 on the original core image 702A, the predicted image 706A is generated. As depicted in the FIG. 7A, the predicted image 706A may include, the bounding boxes, the class labels, and the confidence score associated with the objects within the original core image 702A.

Further, the CNN 112 assigns the confidence score to each prediction of the bounding box and the class label. The confidence score reflects the CNN 112 certainty about an accuracy of the bounding box and the class label. Further, as depicted via a pictorial depiction 700B in FIG. 7B, at maximum instances, the CNN 112 predicted accurate bounding boxes and class labels. However, at one instance marked using an arrow, the CNN 112 misclassified the mud drapes as the bioturbated muddy media. Further, at two instances marked using an arrow, the CNN 112 failed to predict two thin-bedded massive sandstones, which were present in the original core image 702A.

In particular, as depicted via the predicted image 706A, the CNN 112 performed the predictions for the mud drapes with confidence score ranging from 46% to 100%, with an average confidence score of 81%. The confidence scores for the bioturbated sandy media predictions varied between 80% and 100%, with an average confidence score of 98.7%. Further, the massive sandstone is generally identified accurately, with most predictions above 90% confidence score with an average confidence score of 96%. Further, two instances of the massive conglomerate are correctly predicted with an average confidence score of 95%.

Further, the FIG. 7C represents legends 700C, i.e., the class labels that the CNN 112 is configured to detect within the original input image 702A. As depicted in the FIG. 7C, the class labels annotated in the true labels image 704A and predicted by the CNN 112 as depicted via the predicted image 706A may include an empty 702C, a bioturbated sandy media 704C, a massive sandstone 706C, mud drapes 708C, a non-core (scale bar) 710C, broken pieces 712C, a conglomerate 714C (also referred to as the massive conglomerate), a false prediction 716C, and a bioturbated muddy media 718C.

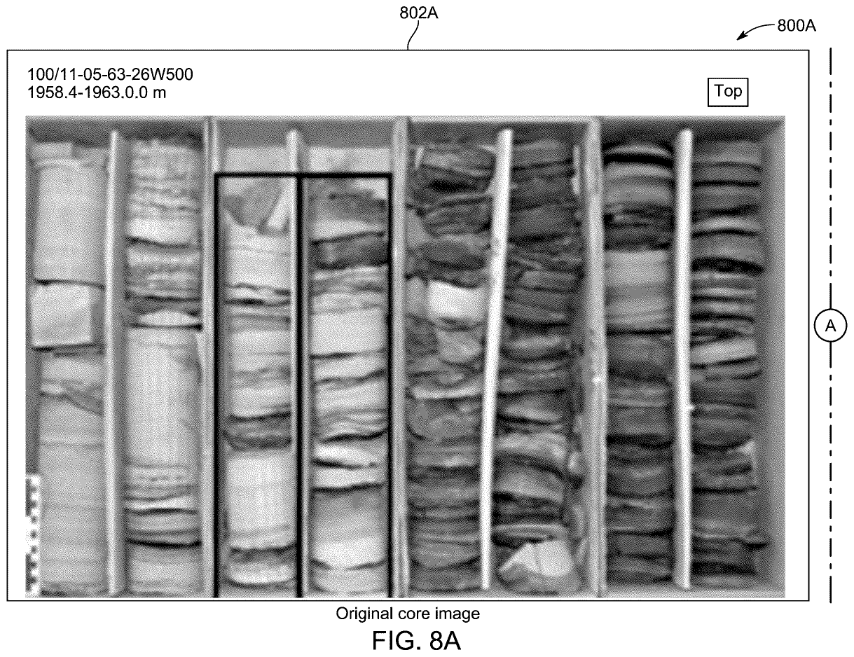

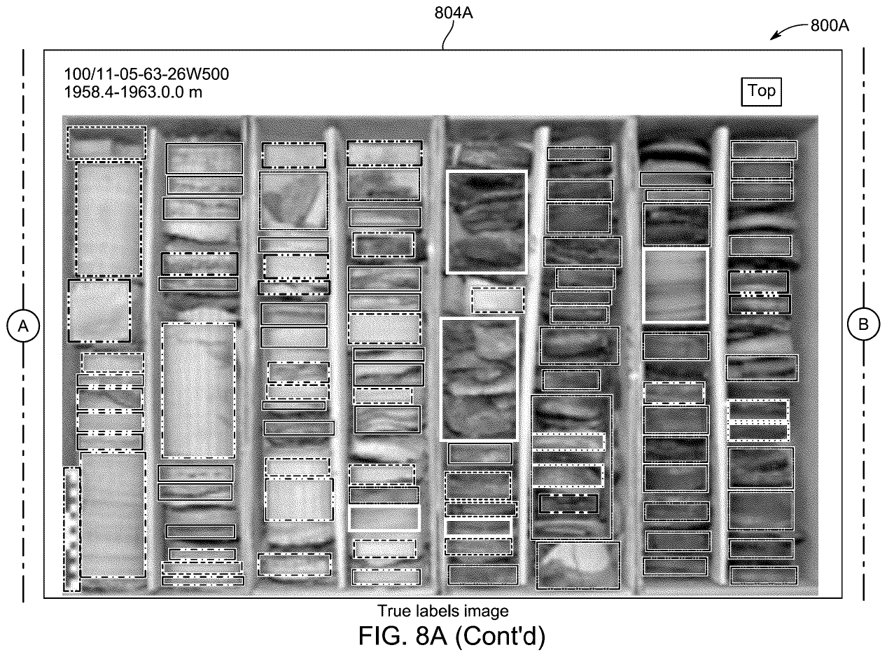

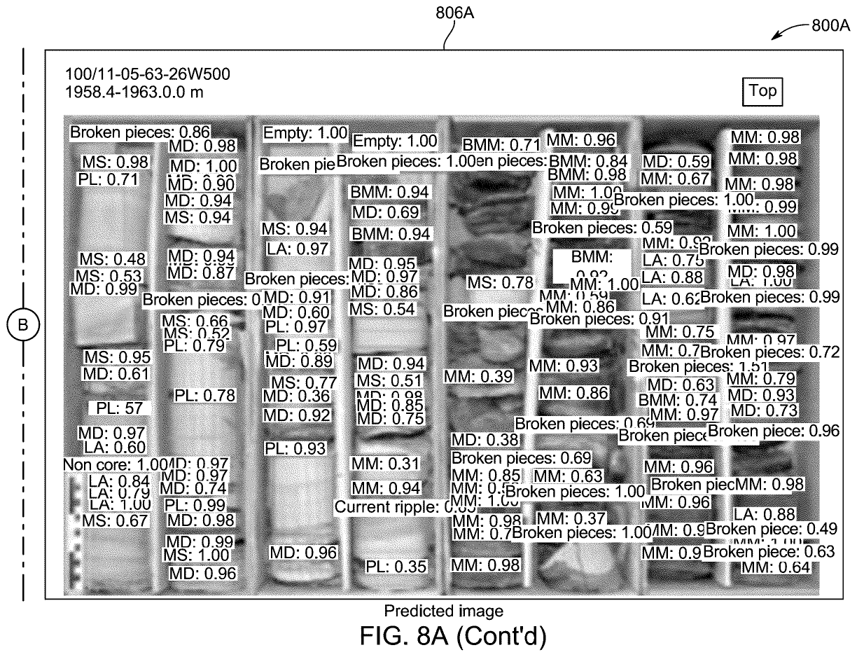

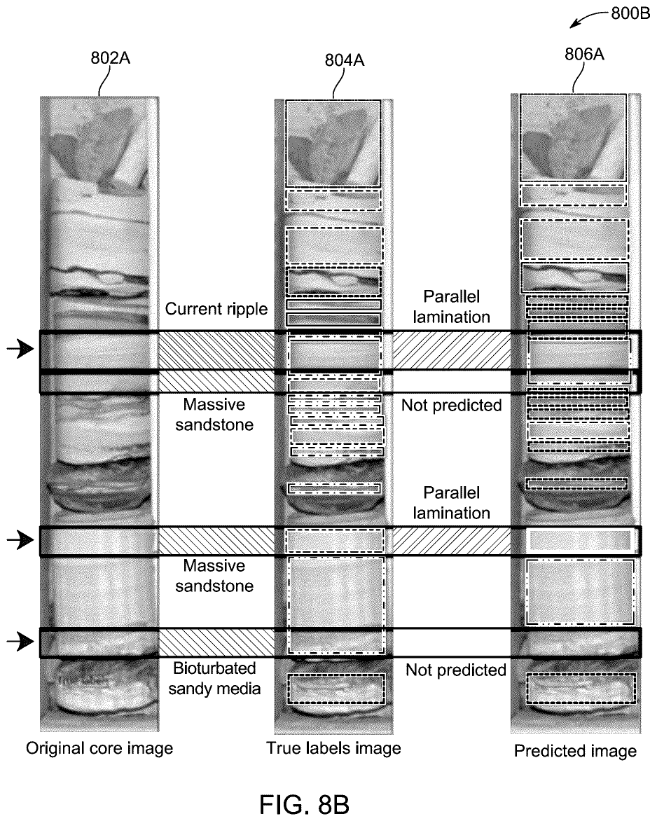

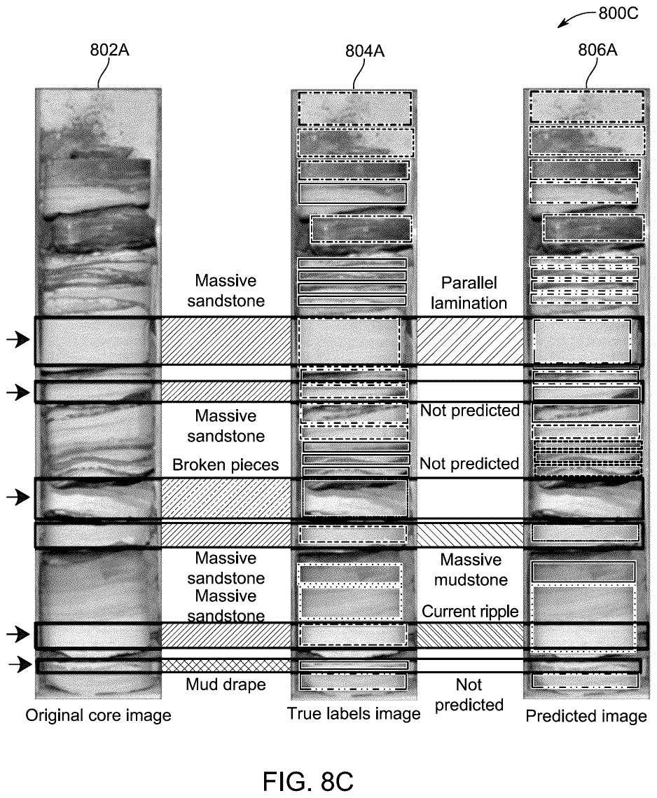

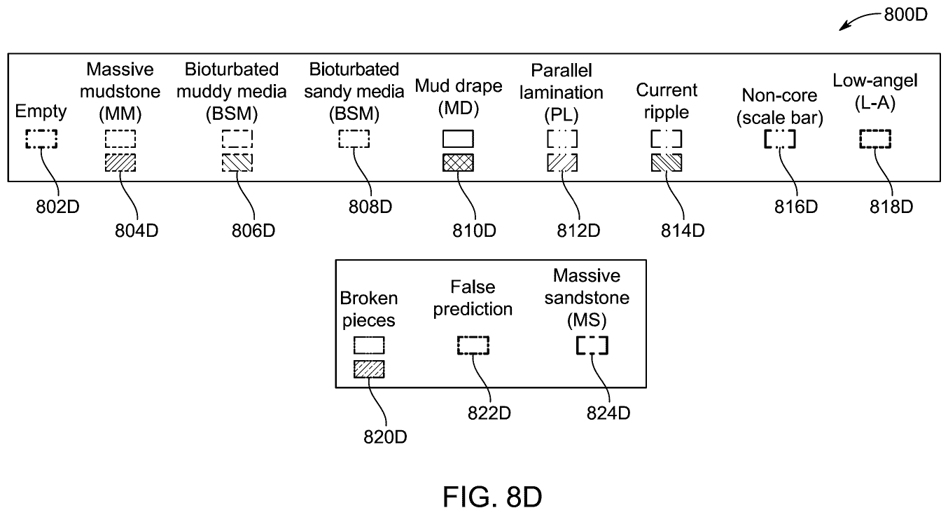

Referring now to FIGS. 8A-8D, the present disclosure provides another exemplary diagram illustrating results of analysis performed by the CNN (i.e., the CNN 112) on an image of the core box containing wide range of sedimentary structures, according to certain embodiments. A pictorial depiction 800A of FIG. 8A represents an original core image 802A (i.e., the image of the core box containing the wide range of the sedimentary structures), a true labels image 804A, and a predicted image 806A. The original core image 802A is provided as an input to the CNN, i.e., the CNN 112. In addition to the original core image 802A, the user (e.g., the geologist) provides an annotated image, i.e., the true labels image 804A to the CNN 112. The true labels image 804A is also referred to as the ground truth image. In particular, to generate the true labels image 804A, the user annotates the original core image 802A with accurate bounding boxes, class labels, and sometimes confidence scores. As depicted in the FIG. 8A, in the true labels image 804A, each class label is represented by a bounding box using a different type of line. A class label annotated in the true labels image 804A includes multiple class labels as depicted via FIG. 8D. Further, based on processing performed by the CNN 112 on the original core image 802A, the predicted image 806A is generated. As depicted in the FIG. 8A, the predicted image 806A may include, the bounding boxes, the class labels, and the confidence score associated with the objects within the original core image 802A.

Further, the CNN 112 assigns the confidence score to each prediction of the bounding box and the class label. The confidence score reflects the CNN 112 certainty about an accuracy of the bounding box and the class label. Further, as depicted via a pictorial depiction 800B in FIG. 8B, at two instances marked using an arrow, the CNN 112 incorrectly identifies a current ripple and a massive sandstone as parallel lamination, which is another type of sedimentary structure. Further, at two instances marked using an arrow, the CNN 112, fails to detect a bioturbated sandy media, which is a critical sedimentary feature. Further, as depicted via a pictorial depiction 800C in FIG. 8C, at three instances marked using an arrow, the CNN 112 misclassifies a massive sandstone as a parallel lamination, a massive mudstone, and a current ripple. However, at three instances marked using an arrow, the CNN 112 fails to detect the massive sandstone, the broken pieces, and the mud drapes class labels present in the original core image 802A. In particular, as depicted via the predicted image 806A, the confidence scores for the mud drapes and the massive sandstone predictions varied widely, averaging 84.2% and 69%, respectively. Further, the predictions for the low-angle cross-bedding and the parallel lamination had lower average confidence levels, at 71.5% and 68% respectively.

Further, the FIG. 8D represents legends 800D, i.e., the class labels that the CNN 112 is configured to detect within the original input image 802A. As depicted in the FIG. 8D, the class labels annotated in the true labels image 804A and predicted by the CNN 112 as depicted via the predicted image 806A may include an empty 802D, a massive mudstone 804D, a massive sandstone 806D, a bioturbated muddy media 808D, mud drapes 810D, a parallel lamination 812D, a current ripple 814D, a non-core (scale bar) 816D, a low angle 818D, broken pieces 820D, a false prediction 822D, and a bioturbated sandy media 824D.

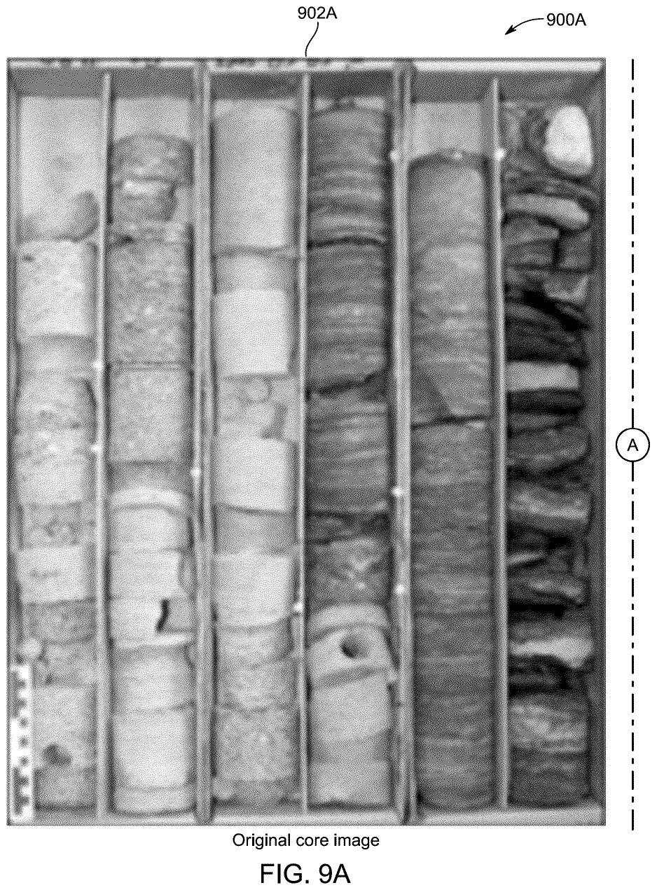

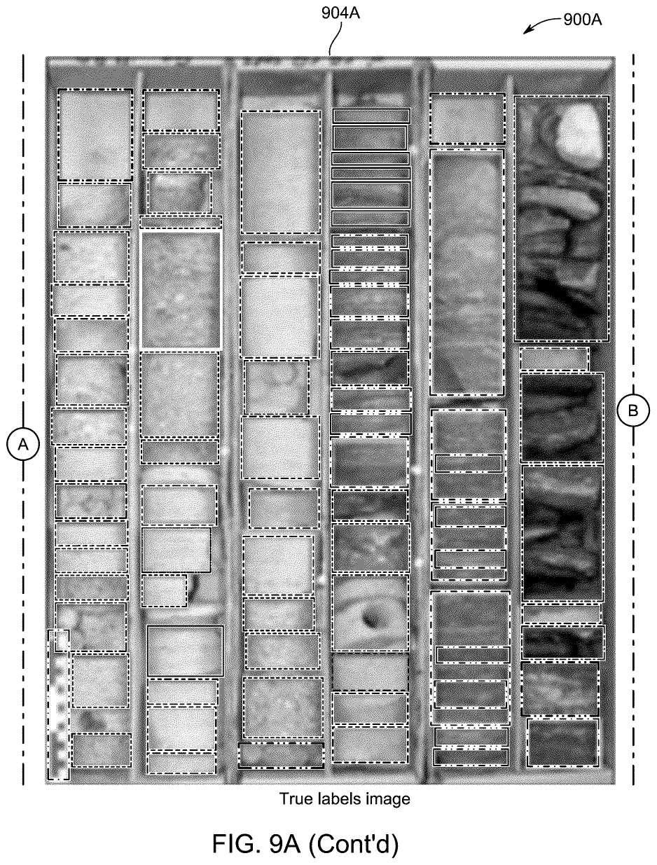

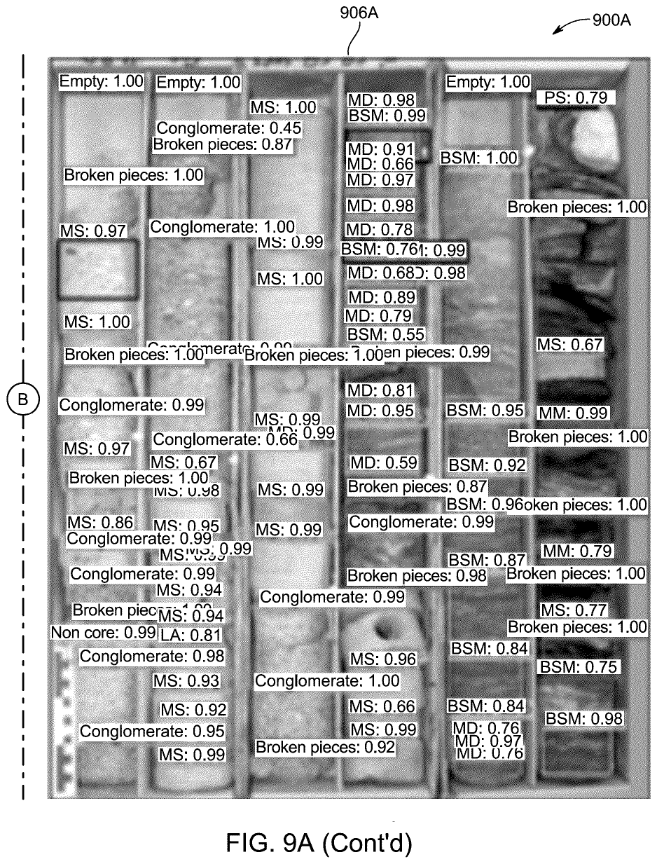

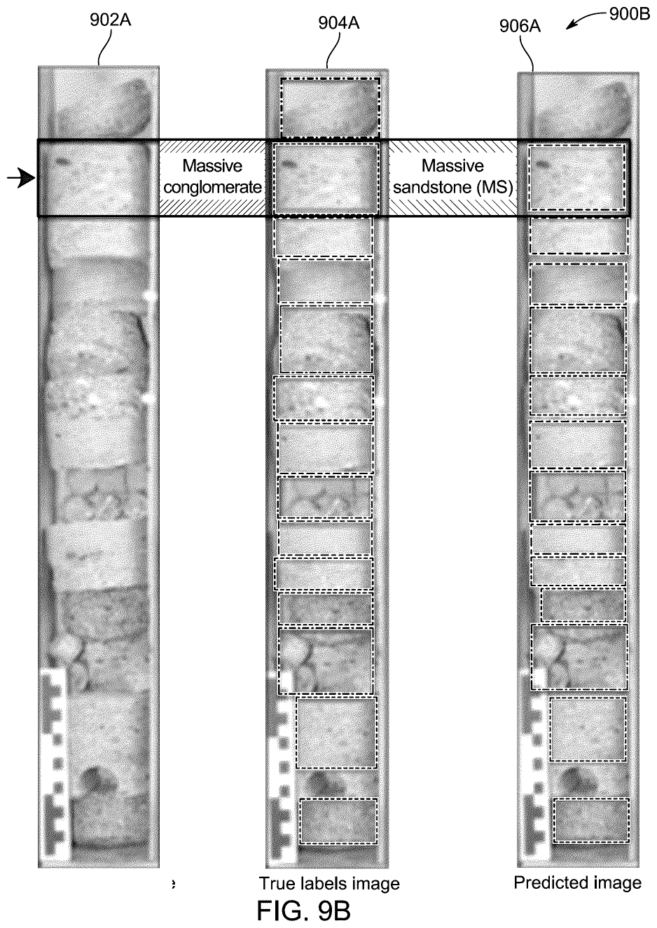

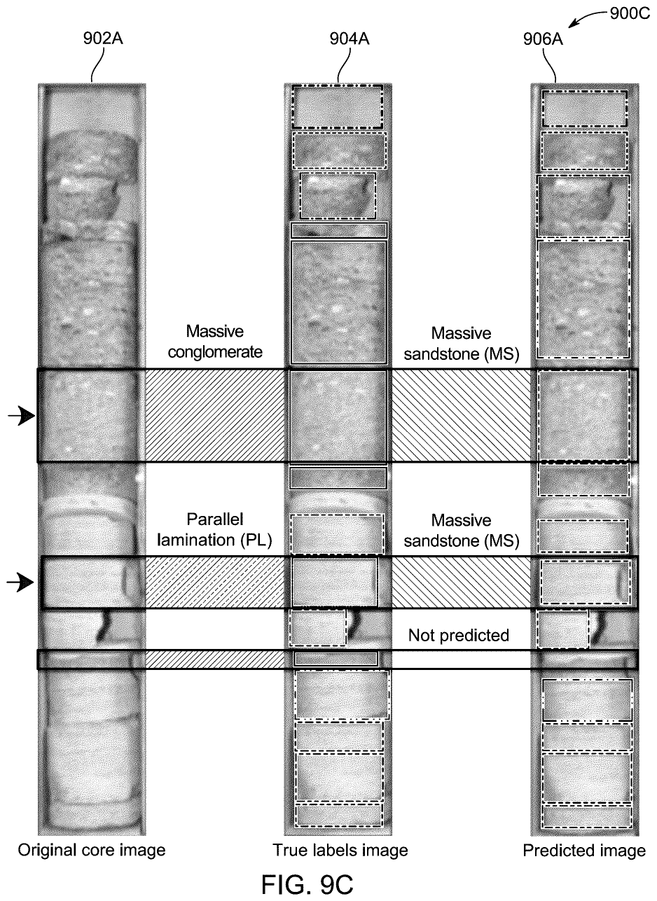

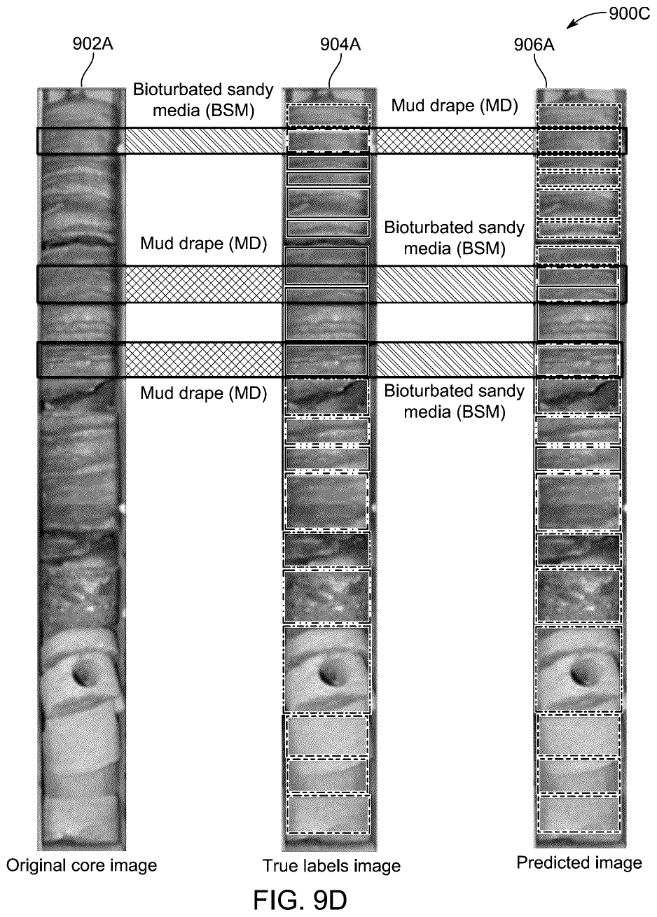

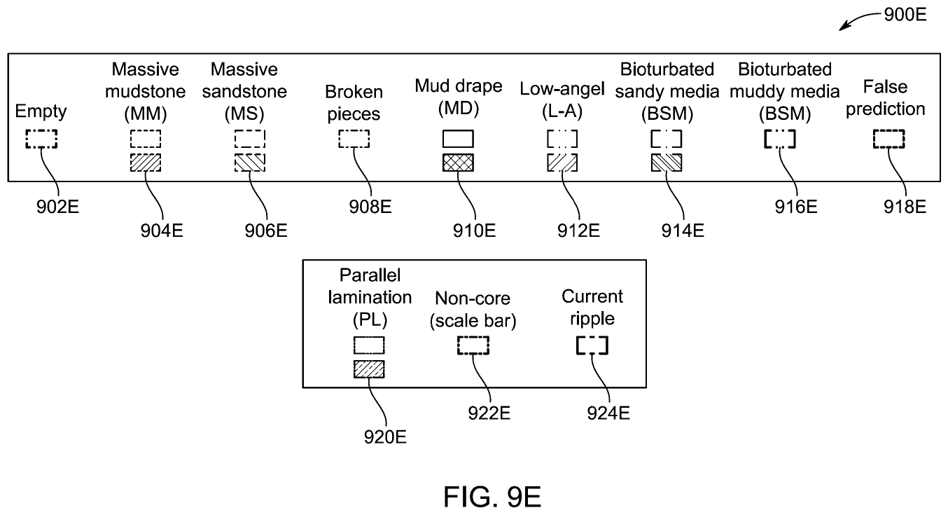

Referring now to FIGS. 9A-9E, the present disclosure provides yet another exemplary diagram illustrating results of analysis performed by the CNN (i.e., the CNN 112) on an image of the core box containing wide range of sedimentary structures, according to certain embodiments. A pictorial depiction 900A of FIG. 9A represents an original core image 902A (i.e., the image of the core box containing the wide range of the sedimentary structures), a true labels image 904A, and a predicted image 906A. The original core image 902A is provided as an input to the CNN, i.e., the CNN 112. In addition to the original core image 902A, the user (e.g., the geologist) provides an annotated image, i.e., the true labels image 904A to the CNN 112. The true labels image 904A is also referred to as the ground truth image. In particular, to generate the true labels image 904A, the user annotates the original core image 902A with accurate bounding boxes, class labels, and sometimes confidence scores. As depicted in the FIG. 9A, in the true labels image 904A, each class label is represented by a bounding box using a different type of line. A class label annotated in the true labels image 904A includes multiple class labels as depicted via FIG. 9E. Further, based on processing performed by the CNN 112 on the original core image 902A, the predicted image 906A is generated. As depicted in the FIG. 9A, the predicted image 906A may include, the bounding boxes, the class labels, and the confidence score associated with the objects within the original core image 902A. Further, the CNN 112 assigns the confidence score to each prediction of the bounding box and the class label. The confidence score reflects the CNN 112 certainty about an accuracy of the bounding box and the class label.

Further, as depicted via a pictorial depiction 900B in FIG. 9B, at one instance marked using an arrow, the CNN 112 incorrectly identifies a massive conglomerate as a massive sandstone, which are different types of sedimentary rocks. Further, as depicted via a pictorial depiction 900C in FIG. 9C, at one instance marked using an arrow, the CNN 112 incorrectly identifies the massive conglomerate as the massive sandstone. Further, at another instance marked using an arrow, the CNN 112 incorrectly identifies marked using an arrow, the CNN 112 incorrectly identifies. Further, at yet another instance marked using an arrow, the CNN 112 fails to detect the massive conglomerate class label present in the original core image 902A. Further, as depicted via a pictorial depiction 900D in FIG. 9D, at one instance marked using an arrow, the CNN 112 incorrectly identifies the bioturbated muddy media as the mud drapes. Further, at another two instances marked using an arrow, the CNN 112 incorrectly identifies the mud drape as the bioturbated muddy media. In particular, as depicted via the predicted image 906A, the confidence score for the massive conglomerate and the massive sandstone predictions ranged widely, with averages of 89.3% and 88%, respectively. Further, the mud drape and the bioturbated muddy media predictions also varied, with average confidence scores of 84% and 82.4%, respectively.

Further, the FIG. 9E represents legends 900E, i.e., the class labels that the CNN 112 is configured to detect within the original input image 902A. As depicted in the FIG. 9E, the class labels annotated in the true labels image 904A and predicted by the CNN 112 as depicted via the predicted image 906A may include an empty 902E, a massive conglomerate 904E, a massive sandstone 906E, broken pieces 908E, mud drapes 910E, a low angle 912E, a bioturbated muddy media 914E, a bioturbated sandy media 916E, a false prediction 918E, a parallel lamination 920E, a non-core (scale bar) 922E, and a fissile shale 924E.

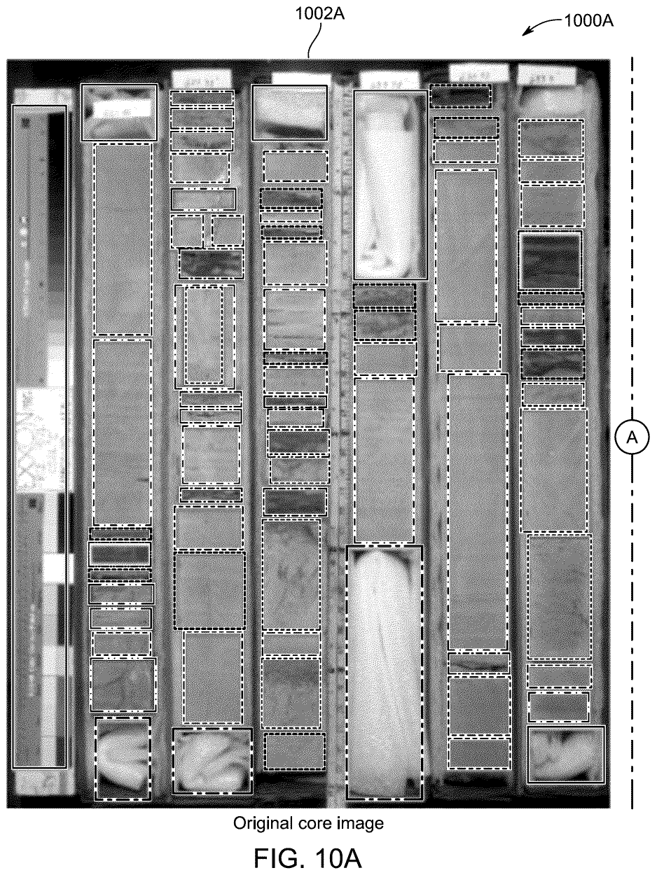

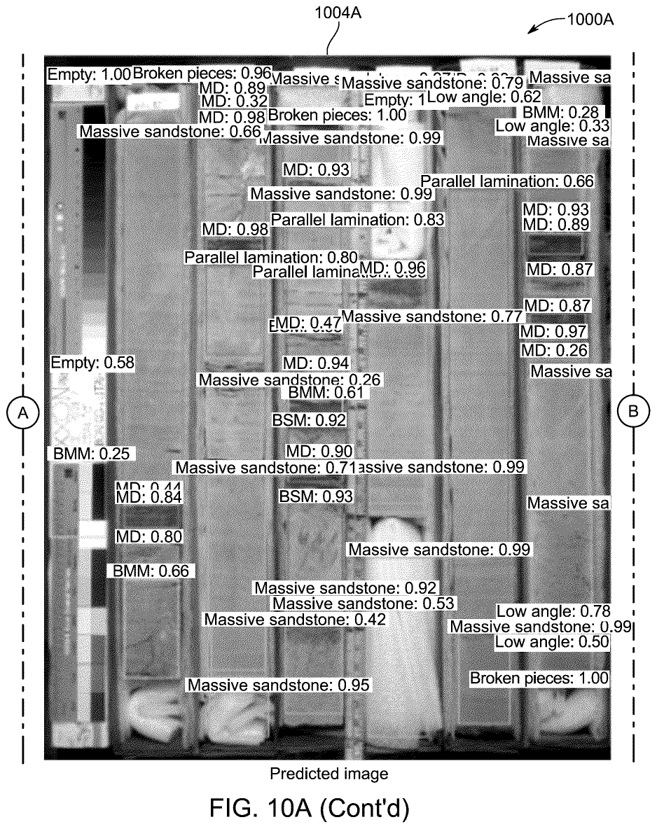

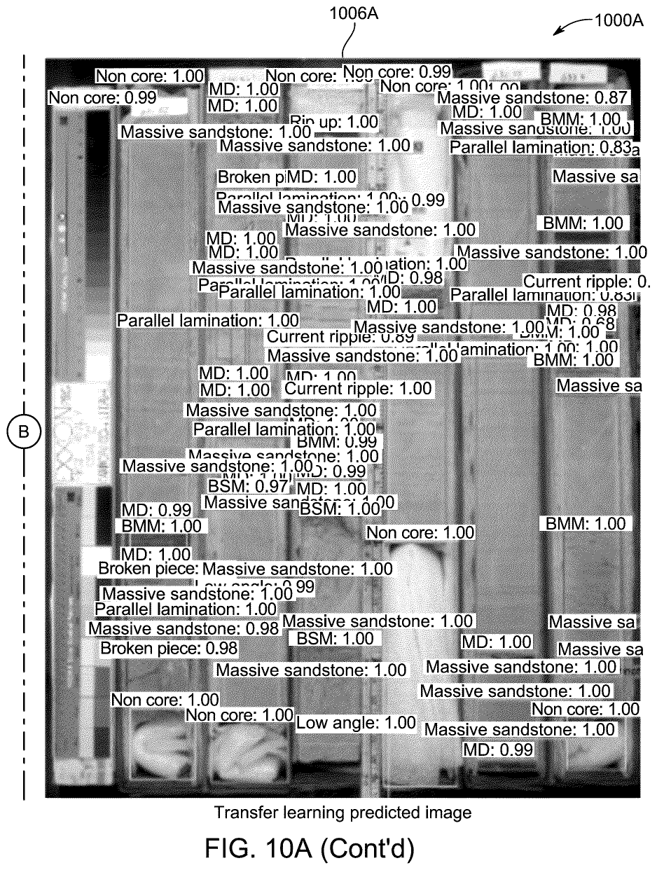

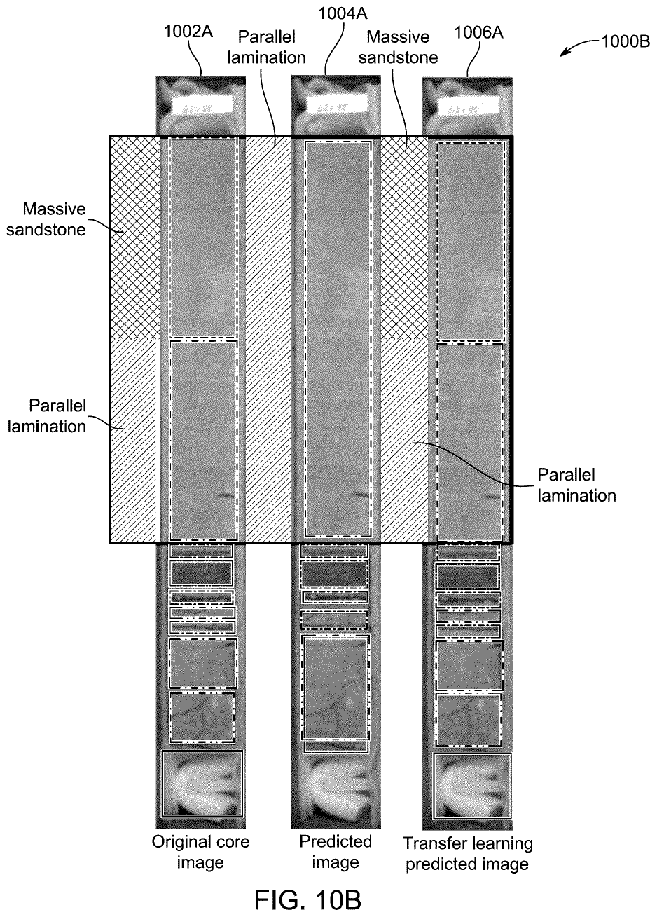

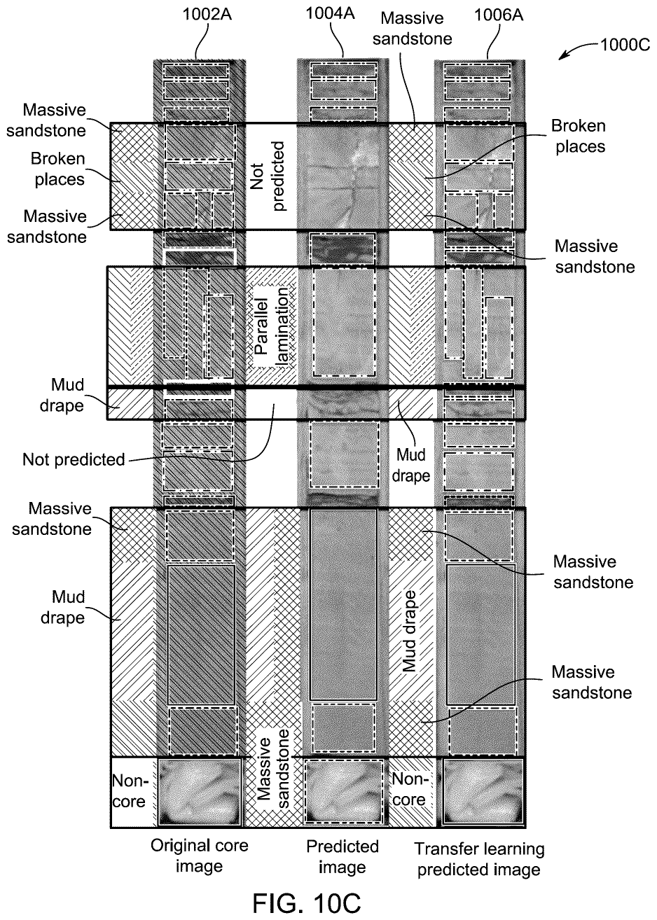

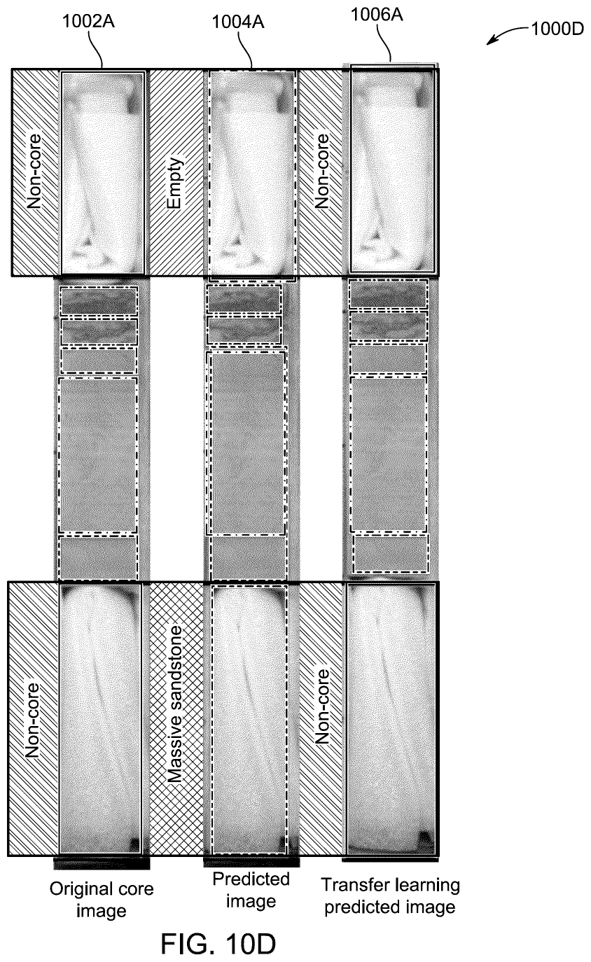

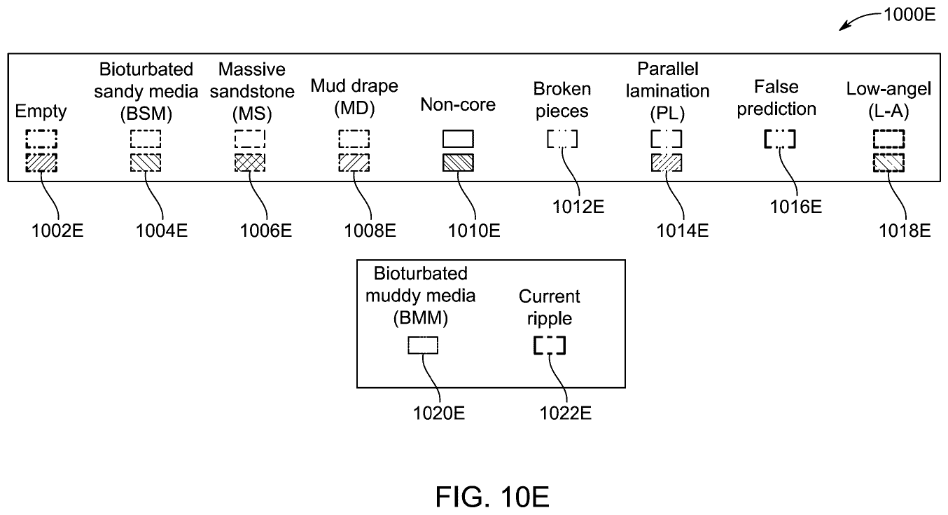

Referring now to FIGS. 10A-10E, the present disclosure provides an exemplary diagram illustrating results of analysis performed by the CNN (i.e., the CNN 112) on an image of the core box before performing transfer learning and after performing transfer learning, according to certain embodiments. A pictorial depiction 1000A of FIG. 10A represents an original core image 1002A with true labels (i.e., the image of the core box containing the wide range of the sedimentary structures), a predicted image 1004A (i.e., the prediction performed by the CNN 112 before performing the transfer learning), and a transfer learning predicted image 1006A (i.e., the prediction performed by the CNN 112 after performing the transfer learning). As explained earlier, the true labels may be annotated by the user, e.g., the geologist.

In an embodiment, to perform the transfer learning, 20 annotated images from the dataset 2 may be used to further train the YOLOv4 that had already been trained on the dataset 1. In the transfer learning, the YOLOv4 is initialized with weights learned from the dataset 1, then fine-tuned the YOLOv4 with a new dataset (i.e., the dataset 2). The transfer learning approach enables the YOLOv4 to adapt and extend its capabilities to recognize image features from the new dataset, even if those image features are not present in an original training dataset (i.e., the dataset 1). By leveraging transfer learning, a small number of core boxes from the dataset 2 are needed to be manually labeled, allowing the rest of the core box detections to be automatically handled by the YOLOv4 after performing the transfer learning. The transfer learning significantly reduces the amount of manual effort required, while still maintaining high detection accuracy for the new dataset.

As depicted in the FIG. 10A, the original core image 1002A is provided as an input to the CNN, i.e., the CNN 112. The original core image 1002A may correspond to a box core image from the dataset 2 that is utilized as a test image to compare the performance of the CNN 112 before the transfer learning is performed and the CNN 112 after transfer learning is performed using 20 images from the dataset 2. This original core image 1002A is composed of various sedimentary structures such as the mud drapes, the massive sandstone, the bioturbated muddy media, the low-angle cross-bedding, the parallel lamination, and the bioturbated sandy media. The original core image 1002A also includes white filling materials in the empty spaces.

In one embodiment, when the transfer learning is not performed on the CNN 112, then based on processing performed by the CNN 112 on the original core image 1002A, the predicted image 1004A is generated. In another embodiment, when the transfer learning is performed on the CNN 112, then based on processing performed by the CNN 112 on the original core image 1002A, the transfer learning predicted image 1006A is generated. As depicted in the FIG. 9A, the predicted image 1004A and the transfer learning predicted image 1006A may include, the bounding boxes, the class labels, and the confidence score associated with the objects within the original core image 1002A. Further, the CNN 112 assigns the confidence score to each prediction of the bounding box and the class label. The confidence score reflects the CNN 112 certainty about an accuracy of the bounding box and the class label. For example, as depicted via the predicted image 1004A, the average confidence scores for the predictions performed using the CNN 112 on which the transfer learning is not performed for the massive sandstone, the mud drape, the parallel lamination, and the bioturbated sandy media are 74%, 75%, 79%, and 70% respectively

Further, as depicted via a pictorial depiction 1000B in FIG. 10B, the predicted image 1004A and the transfer learning predicted image 1006A shows a parallel lamination topped by a massive sandstone. In other words, the parallel lamination structure is detected in both images, i.e., the predicted image 1004A and the transfer learning predicted image 1006A. However, as depicted in the predicted image 1004A, the CNN 112 on which the transfer learning is not performed, was not able to detect the massive sandstone within the original core image 1002A. Whereas the CNN 112 on which the transfer learning is performed, is able to accurately detect the massive sandstone within the original core image 1002A. In this prediction, the CNN 112 on which the transfer learning was performed shows better performance, likely due to its ability to better understand the geological features after fine-tuning.

Similarly, as depicted via a pictorial depiction 1000C in FIG. 10C, the CNN 112 on which the transfer learning is performed, is able to accurately detect sedimentary structure class labels within the original core image 1002A. In this prediction, the CNN 112 on which the transfer learning is performed shows better performance. Further, as depicted via a pictorial depiction 1000D in FIG. 10D, the CNN 112 on which the transfer learning is performed, is able to accurately detect sedimentary structure class labels within the original core image 1002A. In other words, the CNN 112 on which the transfer learning is not performed, incorrectly identifies a non-rock (such as debris or other material) as a massive sandstone. In this prediction, the CNN 112, on which the transfer learning is performed, outperforms the CNN 112, on which the transfer learning is not performed.

Further, the FIG. 10E represents legends 1000E, i.e., the class labels that the CNN 112 is configured to detect within the original input image 1002A. As depicted in the FIG. 10E, the class labels in the predicted image 1004A and the transfer learning predicted image 1006A may include an empty 1002E, a bioturbated sandy media 1004E, a massive sandstone 1006E, mud drapes 1008E, a non-core (scale bar) 1010E, broken pieces 1012E, a parallel lamination 1014E, a false prediction 1016E, a low angle 1018E, a bioturbated muddy media 1020E, and a current ripple 1022E.

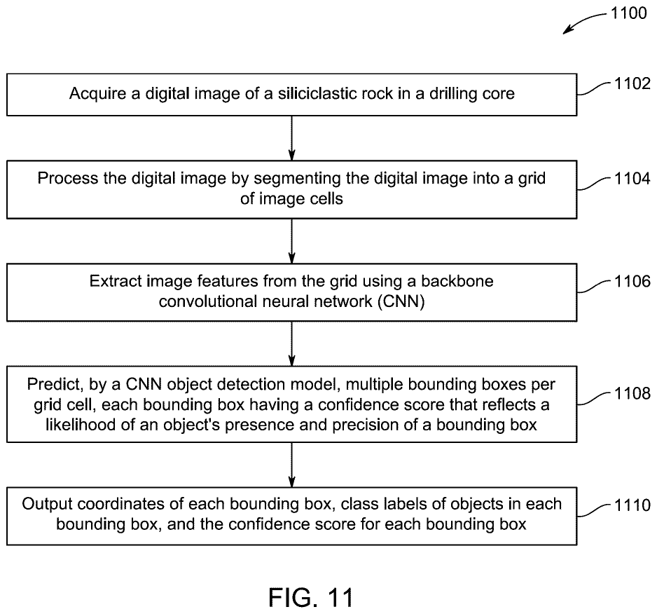

Referring now to FIG. 11, the present disclosure provides an exemplary flowchart of a method 1100 for automated sedimentary structure recognition, according to certain embodiments. In order to perform the sedimentary structure recognition, initially, drilling is performed into the subterranean geologic formation to obtain the drilling core. The subterranean geologic formation refers to the layer or the structure of the rock, the sediment, or the mineral deposits located beneath the earth's surface. These subterranean geologic formations can include a variety of geological features such as aquifers, oil reservoirs, or ore deposits. Further, the drilling core refers to the cylindrical sample of the rock or the sediment extracted from the earth using the drilling rig (e.g., the drilling rig 200), typically to study the composition, the structure, and the properties of subsurface materials, such as those encountered in geological or resource exploration.

Once the drilling core is obtained, at step 1102, the digital image of the siliciclastic sedimentary rock in the drilling core is acquired. In an embodiment, the digital image is acquired via the inbuilt camera (not shown) of the mobile device 108. In some embodiments, the mobile device 108 may receive the digital image from the camera in the drilling core via the network 106. The siliciclastic sedimentary rock is the type of sedimentary rock composed primarily of fragments (clasts) of silicate minerals, such as quartz, feldspar, or rock fragments, that have been weathered and deposited by water or wind. Examples of the siliciclastic sedimentary rock include the sandstone, the shale, the conglomerate, the breccia, and the like. Further, to accurately distinguish the structural features of the siliciclastic sedimentary rock, the cross-bedding angle threshold is used to differentiate between different types of stratified structures, where the stratified structures are layers of strata. The structural features of the siliciclastic sedimentary rocks are the various patterns and structures that form within these siliciclastic sedimentary rocks due to depositional processes, compaction, and diagenesis. Further, the cross-bedding angle threshold may be defined by the user (e.g., the geologist) based on the geological context and a specific type of sedimentary structure being analyzed. For example, the cross-bedding angle threshold might be set to greater than 30° to identify the dunes or the higher-energy environments and less than 30° for lower-energy, more stable depositional settings.

Once the digital image is acquired, at step 1104, the digital image is processed. The processing of the digital image includes segmenting the digital image into the grid of image cells. Once the digital image is segmented into the grid of image cells, at step 1106, image features are extracted using the backbone CNN (e.g., the Darknet), i.e., the CNN 112. The image features may include the edges, the textures, the shapes, the patterns, etc. In an embodiment, apart from the backbone CNN, other similar techniques may be used to extract the image features, either individually or in conjunction with the backbone CNN. Examples of the other similar techniques may include, but are not limited to, the SIFT, the HOG, the SURF, the edge detection filters, and the autoencoders.

Upon extracting the image features, at step 1108, multiple bounding boxes per grid cell are predicted using the CNN object detection model, e.g., the CNN 112. The CNN object detection model may correspond to the YOLOv4. In an embodiment, each bounding box has the confidence score that reflects the likelihood of the object's presence and the precision of the bounding box. The precision of the bounding box is the percentage of the bounding box that is the correct prediction. In other words, each bounding box is assigned the confidence score, which indicates the likelihood of the object being present, and the precision, which measures how accurately the bounding box predicts the object's location relative to the true object. In an embodiment, the confidence score may be predicted using the softmax function. Further, the confidence score may be between ‘0’ to ‘100’ indicating a probability of an object present within the bounding box.

Once the multiple bounding boxes are predicted, at step 1110, the coordinates of each bounding box, the class labels of the objects in each bounding box, and the confidence score for each bounding box is provided as the output to the user. In particular, the digital image of the drilling core annotated with the bounding boxes, the class labels, and the confidence scores are displayed via a display screen (e.g., the I/O unit 116) of the mobile device 108. In an embodiment, the CNN object detection model, i.e., the CNN 112 may be trained to perform the automatic sedimentary structure recognition using a server computer (e.g., the server computer 102). The CNN object detection model may be trained by augmenting the original training data, including the core images of the siliciclastic sedimentary rocks to expand object bounding boxes threefold by applying adjustments to brightness, exposure, and blur. In particular, the CNN object detection model uses the set of core images that depict the siliciclastic sedimentary rocks. The set of core images is used as the training data to train the CNN object detection model to detect the objects (e.g., the geological features) within each of the set of core images. In order to train the CNN object detection model based on the training data, the augmentation technique (also referred to as the augmentation) is applied to each core image in the training data. The augmentation includes adjustments to the brightness, the exposure, and the blur of each core image in the training data to create the modified versions of the original core images present in the training data. The augmentation expands the object bounding boxes threefold, which means the CNN object detection model will learn to recognize the objects in different lighting conditions, exposures, and blur levels, making it more robust to real-world variations in image quality.

Once each image in the training data is augmented, one of the core images is segmented into a grid of image cells. This segmentation helps the CNN object detection model to focus on smaller regions of a core image for object detection. Upon segmenting, the image features are extracted from the grid using the backbone CNN. The image features are extracted at the plurality of different scales. In other words, each image cell in the grid is analyzed using the backbone CNN (usually an initial layer of the CNN 112) to extract meaningful image features like the edges, the textures, the shapes, and the patterns, that helps in identifying the objects. Further, the extraction of the image features at the plurality of different scales means that the backbone CNN is configured to analyze the core image at different resolutions or levels of detail (e.g., fine details in smaller scales and broader features in larger scales). This enables the backbone CNN to detect the objects of different sizes and complexities within the core image.

In an embodiment, during training of the CNN object detection model, the server computer 102 may be configured to perform the transfer learning to enhance an accuracy of the object detection by the CNN object detection model. The transfer learning utilizes the weights from the CNN object detection model applied to the collection of the annotated images obtained from various the initial datasets and fine-tunes the CNN object detection model using the annotated images from the second dataset. The annotated images (i.e., the images with true labels) refer to images that have been labeled or marked with metadata that provides information about specific features or objects within each image. The second dataset includes the box core images that present the fluvial, the shoreface, and the delta deposition with various lithologies (i.e., physical and chemical characteristics of the siliciclastic sedimentary rocks). Further, the transfer learning includes fine-tuning the CNN object detection model using the annotated images from the box core images that present the fluvial, the shoreface, and the delta deposition with the various lithologies. During the training of the CNN object detection model, the server computer 102 uses the plurality of classes for different sedimentary structures and the three background classes. The plurality of classes may include, for example, the mud drapes, the massive sandstone, the bioturbated muddy media, the massive mudstone, and the like. Further, the three background classes may include, the broken pieces, the empty, and the scale bar.

Further, in an embodiment, in order to train the CNN object detection model using data with the unbalanced classes, the server computer 102 may exclude the classes with fewer than the predetermined number of bounding boxes, with the exception of the fissile shale class. In other words, the server computer 102 may exclude the classes from the training dataset with fewer than the predetermined number of bounding boxes (e.g., 40 bounding boxes). The fissile shale class is the exception, even if the fissile shale class has fewer bounding boxes than the predetermined number of bounding boxes (i.e., 40 bounding boxes) and is not excluded from the training data. Further, the server computer 102 applies the NMS to filter out the overlapping bounding boxes and retain those non-overlapping bounding boxes with the highest confidence score (e.g., the non-overlapping bounding boxes with a confidence score of 90 and above).

Further, in an embodiment, the mobile device 108 may include a user interface screen displayed on the display screen (i.e., the I/O unit 116) of the mobile device 108 with an input class of sedimentary structure. The user interface screen enables the user to provide an input, such as selecting or entering data related to a specific sedimentary structure (e.g., the sandstone, the shale, the bioturbated media) that the mobile can detect and classify in each of the plurality of digital images. In an embodiment, based on the input from the user, the drilling is performed into the subterranean geologic formation to obtain a plurality of drilling cores. Further, the plurality of digital images of the plurality of drilling cores is sequentially acquired using the mobile device 108. Upon acquiring the plurality of digital images, a first digital image of the plurality of digital images is processed by segmenting the first digital image into the grid of image cells. Further, the image features are extracted from the grid of the first digital image using the backbone CNN.

Upon extracting the image features, the multiple bounding boxes per image cell are predicted using the CNN object detection model. In an embodiment, each bounding box has the confidence score that reflects the likelihood of the object's presence and the precision of the bounding box. Further, the precision of the bounding box is the percentage of the bounding boxes that is the correct prediction. Once the multiple bounding boxes are predicted, detect whether an object predicted by the CNN object detection model is greater than a predetermined confidence score (e.g., a confidence score of 70) for the input of the particular class. Further, a notification that the input of the particular class has been detected in the first digital image of the drilling core is provided as the output to the user when the object predicted by the CNN object detection model is greater than the predetermined confidence score (e.g., the confidence score of 70) for the input class. Thereafter, the steps of the processing, the extracting, the predicting, the detecting, and the outputting steps are repeated for other digital images of the plurality of digital images.

In particular, the present disclosure provides an innovative and automated approach for identifying the sedimentary structures in core-box images (also referred to as the box core images) using the backbone CNN and the CNN object detection model (i.e., YOLOv4 Darknet framework). The automated technique used in the present disclosure demonstrates impressive efficiency and accuracy, achieving a mean average precision of 92.8% and an Intersection over Union (IoU) of 80.8%, demonstrating a high correlation between the predicted and true labels. These results mark a significant advancement in automating geological analyses, potentially reducing the time and effort traditionally spent on manual identification.

Further, through the use of advanced techniques such as labeling, data augmentation, and transfer learning, the CNN object detection model has proven highly adaptable to diverse datasets. This enables the CNN object detection model to accurately distinguish between various sedimentary structures, enhancing the precision of geological assessments. Further, the disclosed technique minimizes human error and boosts the reliability of the analysis performed by the CNN object detection model. The disclosed technique not only streamlines sedimentary structure identification but also opens new possibilities for rapid, precise, and objective exploration of geological data. Additionally, the disclosed technique holds the potential to transform core analysis practices in both industrial and academic settings. The disclosed automated technique provides fast, reliable, and precise results, minimizes human error, and eases the workload of geoscientists (e.g., the user), allowing the geoscientists to concentrate on more complex aspects of their work.

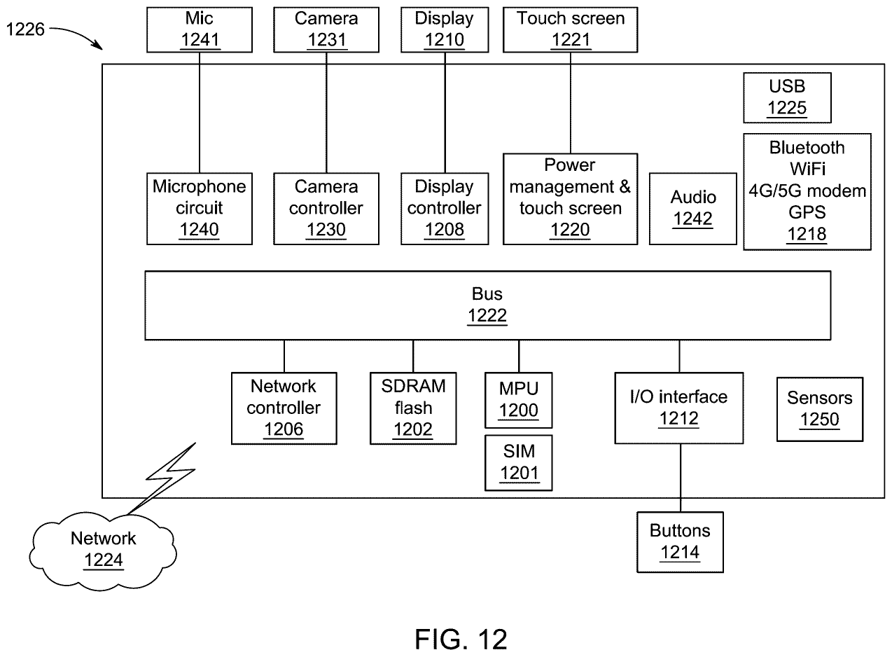

Referring now to FIG. 12, the present disclosure provides an exemplary illustration of a non-limiting example of a mobile device (same as the mobile device 108), according to certain embodiments. In one implementation, the functions and processes of the mobile device 108 may be implemented by one or more respective processing circuits 1226. A processing circuit includes a programmed processor as a processor includes circuitry. The processing circuit may also include devices such as an Application Specific Integrated Circuit (ASIC) and conventional circuit components arranged to perform the recited functions. Note that circuitry refers to a circuit or system of circuits. Herein, the circuitry may be in one computer system (as illustrated in FIGS. 1 and 12) or may be distributed throughout a network of computer systems. Hence, the circuitry of a server computer system (e.g., a server computer 102), for example may be in only one server or distributed among different servers/computers.

Next, a hardware description of the processing circuit 1226 according to exemplary embodiments is described with reference to FIG. 12. In FIG. 12, the processing circuit 1226 includes a Mobile Processing Unit (MPU) 1200, which performs the processes described herein. The process data and instructions may be stored in a memory 1202. These processes and instructions may also be stored on a portable storage medium or may be stored remotely. The processing circuit 1226 may have a replaceable Subscriber Identity Module (SIM) 1201 that contains information that is unique to the network service of the mobile device 108.

Further, the advancements of the present disclosure are not limited by the form of the computer-readable media on which the instructions of the inventive process are stored. For example, the instructions may be stored in a FLASH memory, a Secure Digital Random Access Memory (SDRAM), the RAM, the ROM, a Programmable Read-Only Memory (PROM), an Erasable Programmable Read-Only Memory (EPROM), an Electrically Erasable Programmable Read Only Memory (EEPROM), solid-state hard disk or any other information processing device with which the processing circuit 1226 communicates, such as a server or a computer.

Further, the advancements of the present disclosure may be provided as a utility application, background daemon, or component of an operating system, or combination thereof, executing in conjunction with the MPU 1200 and a mobile operating system such as an Android, a Microsoft® Windows® 10 Mobile, an Apple IOS® and other systems known to those skilled in the art.

In order to achieve the processing circuit 1226, the hardware elements may be realized by various circuitry elements, known to those skilled in the art. For example, the MPU 1200 may be a Qualcomm mobile processor, a NVIDIA mobile processor, an Atom® processor from Intel Corporation of America, a Samsung mobile processor, or an Apple A7 or greater mobile SoC, or may be other processor types that would be recognized by one of ordinary skill in the art. Alternatively, the MPU 1200 may be implemented on a Field-Programmable Gate Array (FPGA), the ASIC, a Programmable Logic Device (PLD) or using discrete logic circuits, as one of ordinary skill in the art would recognize. Further, the MPU 1200 may be implemented as multiple processors cooperatively working in parallel to perform the instructions of the inventive processes described above.

The processing circuit 1226 in FIG. 12 also includes a network controller 1206, such as an Intel Ethernet Professional (PRO) network interface card from an Intel Corporation of America, for interfacing with a network 1224. As can be appreciated, the network 1224 can be a public network, such as the Internet, or a private network such as the LAN or the WAN, or any combination thereof and can also include PSTN or an Integrated Services Digital Network (ISDN) sub-networks. The network 1224 can also be wired, such as an Ethernet network. The processing circuit may include various types of communications processors for wireless communications including a Third Generation (3G), a Fourth Generation (4G), and a Fifth Generation (5G) wireless modems, a WiFi®, a Bluetooth®, a Global Positioning System (GPS), or any other wireless form of communication that is known.

The processing circuit 1226 includes a Universal Serial Bus (USB) controller 1225 which may be managed by the MPU 1200.

The processing circuit 1226 further includes a display controller 1208, such as a NVIDIA® GeForce® Texel eXtreme (GTX), or Quadro® graphics adaptor from a NVIDIA Corporation of America for interfacing with a display 1210. An Input/Output (I/O) interface 1212 interfaces with buttons 1214, such as for volume control. In addition to the I/O interface 1212 and the display 1210, the processing circuit 1226 may further include a microphone 1241 and one or more cameras 1231. The microphone 1241 may have an associated circuitry 1240 for processing the sound into digital signals. Similarly, the camera 1231 may include a camera controller 1230 for controlling image capture operation of the camera 1231. In an exemplary aspect, the camera 1231 may include a Charge Coupled Device (CCD). The processing circuit 1226 may include an audio circuit 1242 for generating sound output signals and may include an optional sound output port.

The power management and a touch screen controller 1220 manage power used by the processing circuit 1226 and a touch control. A communication bus 1222, which may be an Industry Standard Architecture (ISA), an Extended Industry Standard Architecture (EISA), a Video Electronics Standards Association (VESA), a Peripheral Component Interface (PCI), or similar, for interconnecting all of the components of the processing circuit 1226. A description of the general features and functionality of the display 1210, the buttons 1214, as well as the display controller 1208, the power management controller 1220, the network controller 1206, and the I/O interface 1212 is omitted herein for brevity as these features are known.

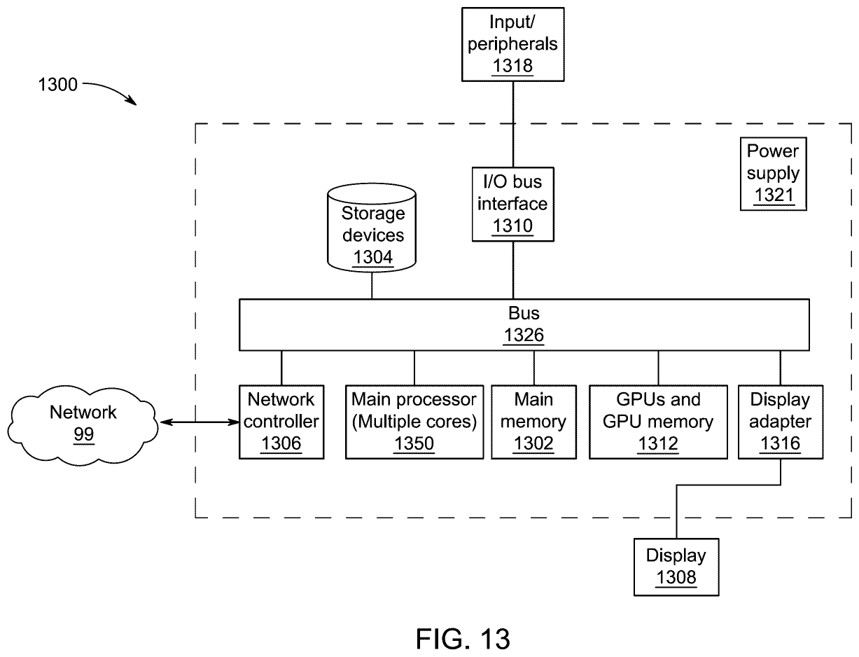

Referring now to FIG. 13, the present disclosure provides a block diagram illustrating an example computer system 1300 for implementing the machine learning training and inference methods, according to certain embodiment. The computer system 1300 (e.g., the system 100) may be an Artificial Intelligence (AI) workstation running an Operating System (OS), for example, an Ubuntu Linux OS, Windows, a version of a Unix OS, or a Mac OS. The computer system 1300 may include one or more CPUs 1350 having multiple cores. The computer system 1300 may include a graphics board 1312 having multiple Graphics Processing Units (GPUs), each GPU having a GPU memory. The graphics board 1312 may perform many mathematical operations of the disclosed machine learning methods. The computer system 1300 includes a main memory 1302, typically a RAM, which contains the software being executed by processing cores 1350 and GPUs 1312, as well as a non-volatile storage device 1304 for storing data and the software programs. Several interfaces for interacting with the computer system 1300 may be provided, including an I/O bus interface 1310, Input/Peripherals 1318 such as a keyboard, a touchpad, a mouse, a display adapter 1316 and one or more displays 1308, and a network controller 1306 to enable wired or wireless communication through a network 99. The interfaces, memory and processors may communicate over the system bus 1326. The computer system 1300 includes a power supply 1321, which may be a redundant power supply.

In some embodiments, the computer system 1300 may include a server CPU and a graphics card by a NVIDIA, in which the GPUs have multiple Compute Unified Device Architecture (CUDA) cores. In some embodiments, the computer system 1300 may include a machine learning engine 1312.

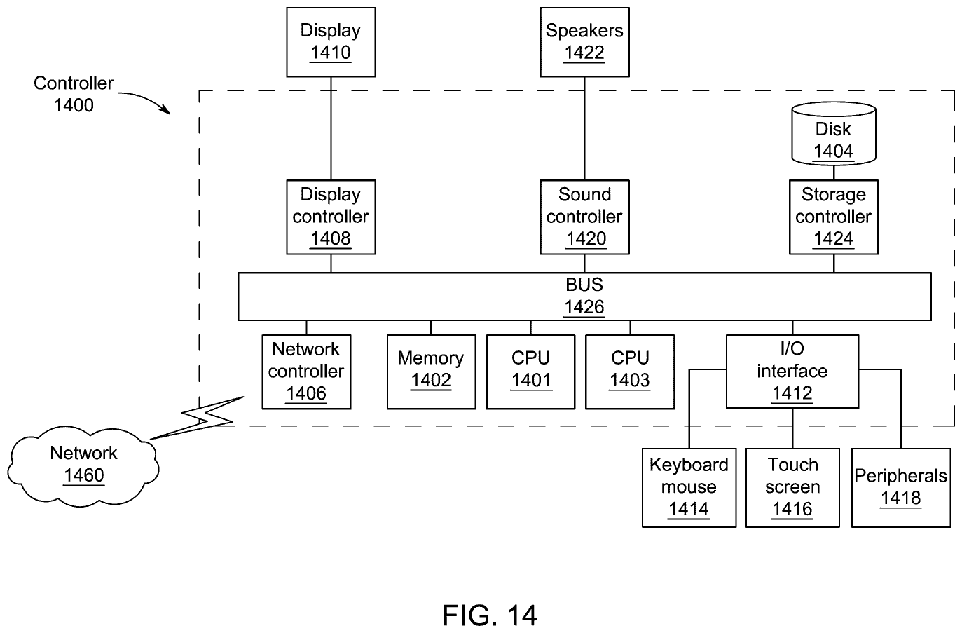

Next, further details of the hardware description of the computing environment according to exemplary embodiments is described with reference to FIG. 14. In FIG. 14, a controller 1400 that is described is representative of the system 100 of FIG. 1 in which the controller 1400 is a computing device which includes a CPU 1401 which performs the processes described above/below. The process data and instructions may be stored in a memory 1402. These processes and instructions may also be stored on a storage medium disk 1404 such as a Hard Disk Drive (HDD) or a portable storage medium or may be stored remotely.

Further, the claims are not limited by the form of the computer-readable media on which the instructions of the inventive process are stored. For example, the instructions may be stored on Compact Disks (CDs), Digital Versatile Discs (DVDs), a FLASH memory, a RAM, a ROM, a PROM, an EPROM, an EEPROM, a hard disk or any other information processing device with which the computing device communicates, such as a server or a computer.

Further, the claims may be provided as a utility application, background daemon, or component of an operating system, or combination thereof, executing in conjunction with the CPU 1401, the CPU 1403 and an Operating System (OS) such as a Microsoft Windows 7, a Microsoft Windows 10, a UNIX, a Solaris, a LINUX, an Apple MAC-OS and other systems known to those skilled in the art.

The hardware elements in order to achieve the computing device may be realized by various circuitry elements, known to those skilled in the art. For example, the CPU 1401 or the CPU 1403 may be a Xenon or a Core processor from Intel of America or an Opteron processor from Advanced Micro Devices (AMD) of America, or may be other processor types that would be recognized by one of ordinary skill in the art. Alternatively, the CPU 1401, the CPU 1403 may be implemented on a FPGA, an ASIC, a PLD or using discrete logic circuits, as one of ordinary skill in the art would recognize. Further, the CPU 1401, the CPU 1403 may be implemented as multiple processors cooperatively working in parallel to perform the instructions of the inventive processes described above.

The computing device in FIG. 14 also includes a network controller 1406, such as an Intel Ethernet Professional (PRO) network interface card from an Intel Corporation of America, for interfacing with a network 1460. As can be appreciated, the network 1460 can be a public network, such as the Internet, or a private network such as a LAN or a WAN, or any combination thereof and can also include a PSTN or an Integrated Services Digital Network (ISDN) sub-networks. The network 1460 can also be wired, such as an Ethernet network, or can be wireless such as a cellular network including EDGE, Third Generation (3G), and Fourth Generation (4G) wireless cellular systems. The wireless network can also be a Wi-Fi, a Bluetooth, or any other wireless form of communication that is known.

The computing device further includes a display controller 1408, such as the NVIDIA GeForce Giga Texel Shader eXtreme (GTX) or a Quadro graphics adaptor from a NVIDIA Corporation of America for interfacing with display 1410, such as a Hewlett Packard (HP) L2445w LCD monitor. A general purpose I/O interface 1412 interfaces with a keyboard and/or a mouse 1414 as well as a touch screen panel 1416 on or separate from the display 1410. The general purpose I/O interface 1410 also connects to a variety of peripherals 1418 including printers and scanners, such as an OfficeJet or a DeskJet from the HP.

A sound controller 1420 is also provided in the computing device, such as a Sound Blaster X-Fi Titanium from Creative, to interface with speakers/microphones 1422 thereby providing sounds and/or music.

A general purpose storage controller 1424 connects the storage medium disk 1404 with a communication bus 1426, which may be an Industry Standard Architecture (ISA), an Extended Industry Standard Architecture (EISA), a Video Electronics Standards Association (VESA), a Peripheral Component Interconnect (PCI), or similar, for interconnecting all of the components of the computing device. A description of the general features and functionality of the display 1410, the keyboard and/or mouse 1414, as well as the display controller 1408, the storage controller 1424, the network controller 1406, the sound controller 1420, and the general purpose I/O interface 1412 is omitted herein for brevity as these features are known.

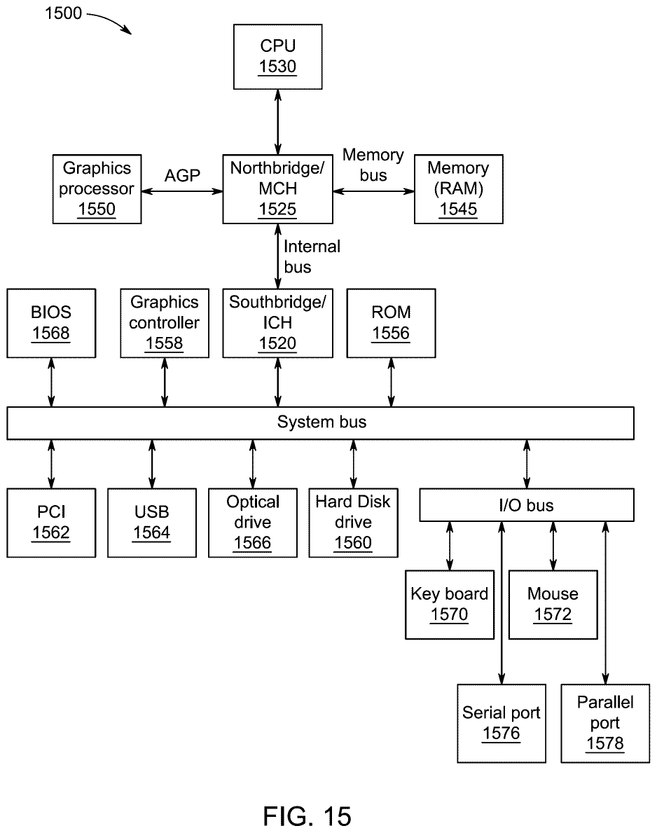

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 15.

FIG. 15 shows a schematic diagram of a data processing system 1500, according to certain embodiments, for performing the functions of the exemplary embodiments. The data processing system 1500 is an example of a computer in which code or instructions implementing the processes of the illustrative embodiments may be located.

In FIG. 15, the data processing system 1500 employs a hub architecture including a North Bridge and a Memory Controller Hub (NB/MCH) 1525 and a South Bridge and I/O Controller Hub (SB/ICH) 1520. The CPU 1530 is connected to the NB/MCH 1525. The NB/MCH 1525 also connects to the memory 1545 via a memory bus and connects to a graphics processor 1550 via an Accelerated Graphics Port (AGP). The NB/MCH 1525 also connects to the SB/ICH 1520 via an internal bus (e.g., a unified media interface or a direct media interface). The CPU 1530 may contain one or more processors and even may be implemented using one or more heterogeneous processor systems.

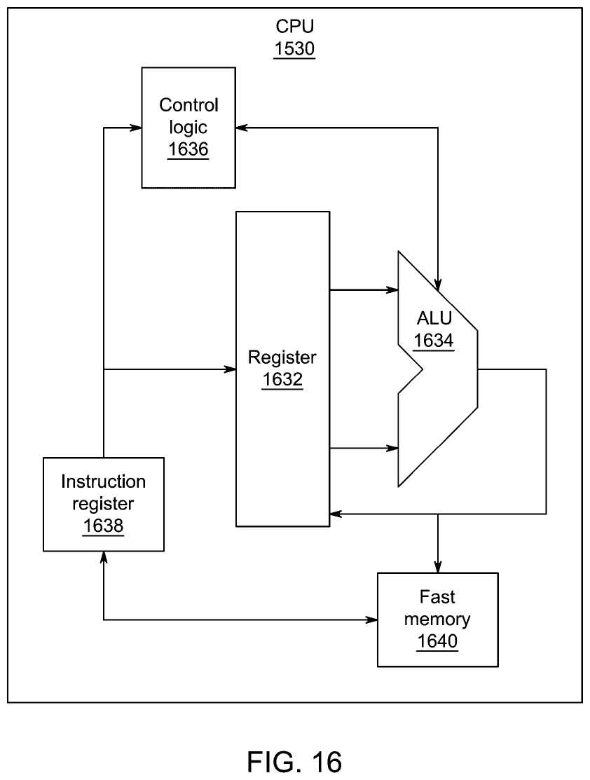

For example, FIG. 16 shows one implementation of the CPU 1630. In one implementation, an instruction register 1638 retrieves instructions from a fast memory 1640. At least part of these instructions is fetched from the instruction register 1638 by a control logic 1636 and interpreted according to the instruction set architecture of the CPU 1630. Part of the instructions can also be directed to a register 1632. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using an Arithmetic Logic Unit (ALU) 1634 that loads values from the register 1632 and performs logical and mathematical operations on the loaded values according to the instructions. The results from these operations can be feedback into the register 1632 and/or stored in the fast memory 1640. According to certain implementations, the instruction set architecture of the CPU 1630 can use a reduced instruction set architecture, a complex instruction set architecture, a vector processor architecture, a very large instruction word architecture. Furthermore, the CPU 1630 can be based on a Von Neuman model or a Harvard model. The CPU 1630 can be a digital signal processor, an FPGA, an ASIC, a Programmable Logic Array (PLA), a PLD, or a Complex Programmable Logic Device (CPLD). Further, the CPU 1630 can be an x86 processor by the Intel or by the AMD; an Advanced Reduced Instruction Set Computing (RISC) Machine (ARM) processor, a power architecture processor by, e.g., an International Business Machines Corporation (IBM); a Scalable Processor Architecture (SPARC) processor by Sun Microsystems or by Oracle; or other known CPU architecture.

Referring again to FIG. 15, the data processing system 1500 can include that the SB/ICH 1520 is coupled through a system bus to an I/O Bus, a ROM 1556, a Universal Serial Bus (USB) port 1564, a flash binary I/O system (BIOS) 1468, and a graphics controller 1558. PCI/PCIe devices can also be coupled to a SB/ICH 1488 through a PCI bus 1562.

The PCI devices may include, for example, Ethernet adapters, add-in cards, and PC cards for notebook computers. The HDD 1560 and an optical drive 1566 (e.g., CD-ROM) can use, for example, an Integrated Drive Electronics (IDE) or a Serial Advanced Technology Attachment (SATA) interface. In one implementation, the I/O bus can include a super I/O (SIO) device.

Further, the HDD 1560 and the optical drive 1566 can also be coupled to the SB/ICH 1520 through a system bus. In one implementation, a keyboard 1570, a mouse 1572, a parallel port 1578, and a serial port 1576 can be connected to the system bus through the I/O bus. Other peripherals and devices that can be connected to the SB/ICH 1520 using a mass storage controller such as a SATA or a Parallel Advanced Technology Attachment (PATA), an Ethernet port, an ISA bus, a Low Pin Count (LPC) bridge, a System Management (SM) bus, a Direct Memory Access (DMA) controller, and an Audio Compressor/Decompressor (Codec).

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

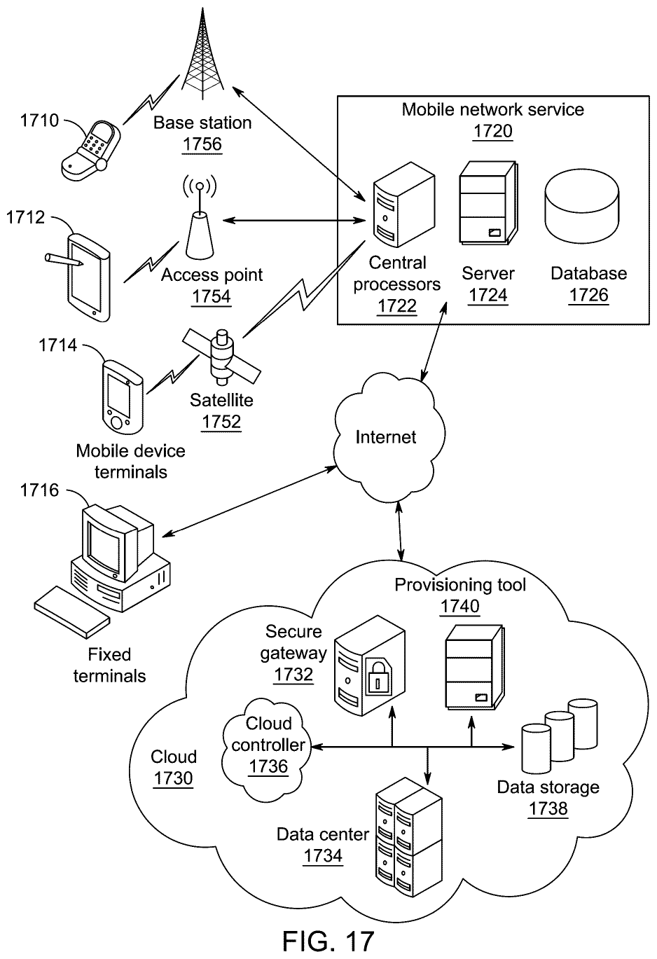

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 17, in addition to various human interface and communication devices (e.g., display monitors, smart phones, tablets, Personal Digital Assistants (PDAs)). More specifically, FIG. 17 illustrates client devices, including a smartphone 1711, a tablet 1712, a mobile device terminal 1714 and fixed terminals 1716. These client devices may be commutatively coupled with a mobile network service 1720 via a base station 1756, an access point 1754, a satellite 1752 or via an internet connection. The mobile network service 1720 may comprise central processors 1722, a server 1724 and a database 1726. The fixed terminals 1716 and the mobile network service 1720 may be commutatively coupled via an internet connection to functions in a cloud 1730 that may comprise a security gateway 1732, a data center 1734, a cloud controller 1736, a data storage 1738 and a provisioning tool 1740. The network may be a private network, such as the LAN or the WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope of the present disclosure.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method for automated sedimentary structure recognition, comprising:
acquiring, by a mobile device, a digital image of a siliciclastic sedimentary rock in a drilling core;
processing, by a processing circuitry of the mobile device, the digital image by segmenting the digital image into a grid of image cells;
extracting from each image cell of the grid, using a backbone Convolutional Neural Network (CNN), image features;
predicting, by a CNN object detection model, multiple bounding boxes per grid cell, each bounding box having a confidence score that reflects a likelihood of an object's presence and a precision of a bounding box, wherein the precision of the bounding box is a percentage of the bounding box that is a correct prediction; and
outputting coordinates of each bounding box, class labels of objects in each bounding box, and the confidence score for each bounding box.

2. The method of claim 1, further comprising:
training, by a server computer, the CNN object detection model by augmenting original training data including core images of siliciclastic sedimentary rocks to expand object bounding boxes threefold by applying adjustments to brightness, exposure, and blur;
segmenting one of the core images into a grid of image cells; and
extracting from each image cell of the grid, using the backbone CNN, image features at a plurality of different scales.

3. The method of claim 1, further comprising:
drilling into a subterranean geologic formation to obtain a drilling core; and
acquiring, by the mobile device, the digital image of the siliciclastic sedimentary rock in the drilling core,
wherein to accurately distinguish between structural features of the siliciclastic sedimentary rock, the mobile device uses a cross-bedding angle threshold to differentiate between different types of stratified structures, where the stratified structures are layers of strata.

4. The method of claim 2, further comprising:
performing transfer learning, by the server computer, that utilizes weights from the CNN object detection model applied to a collection of annotated images obtained from various initial datasets and fine-tunes the CNN object detection model using annotated images from a second dataset.

5. The method of claim 2, further comprising;
in order to train the CNN object detection model using data with unbalanced classes, the server computer excludes classes with fewer than a predetermined number of bounding boxes, with an exception of a fissile shale class.

6. The method of claim 2, further comprising:
applying, by the server computer, a Non-Maximum Suppression (NMS) to filter out overlapping bounding boxes and retaining those non-overlapping bounding boxes with a highest confidence score.

7. The method of claim 4, wherein the second dataset includes box core images that present a fluvial, a shoreface, and a delta deposition with various lithologies, and wherein the transfer learning includes fine-tuning the CNN object detection model using the annotated images from the box core images that present the fluvial, the shoreface, and the delta deposition with the various lithologies.

8. The method of claim 2, wherein, during the training by the server computer, the class labels used in the training include a plurality of classes for different sedimentary structures and three background classes.

9. The method of claim 1, further comprising:
displaying, on a display screen of the mobile device, the digital image of the drilling core annotated with the bounding boxes, the class labels, and the confidence score.

10. The method of claim 1, wherein the mobile device includes a user interface screen displayed on a display screen of the mobile device with an input class of sedimentary structure, the method further comprising:
drilling into a subterranean geologic formation to obtain a plurality of drilling cores;
sequentially acquiring, by the mobile device, a plurality of digital images of the plurality of drilling cores;
processing, by a processing circuitry of the mobile device, a first digital image of the plurality of digital images by segmenting the first digital image into a grid of image cells;
extracting from each image cell of the grid, using the backbone CNN, image features;
predicting, by the CNN object detection model, multiple bounding boxes per image cell, each bounding box having a confidence score that reflects the likelihood of an object's presence and a precision of a bounding box, wherein the precision of the bounding box is a percentage of the bounding boxes that is a correct prediction;
detecting whether an object predicted by the CNN object detection model is greater than a predetermined confidence score for the input class;
outputting a notification that the input class has been detected in the first digital image of the drilling core when the input class has been detected; and
repeating the processing, the extracting, the predicting, the detecting, and the outputting steps for other digital images of the plurality of digital images.

11. A system for automated sedimentary structure recognition, comprising:
a mobile device configured to:
acquire a digital image of a siliciclastic sedimentary rock in a drilling core;
process the digital image by segmenting the digital image into a grid of image cells;
extract from each image cell of the grid, using a backbone Convolution Neural Network (CNN), image features;
predict, by a CNN object detection model, multiple bounding boxes per image cell, each bounding box having a confidence score that reflects a likelihood of an object's presence and a precision of a bounding box, wherein the precision of the bounding box is a percentage of the bounding box that is a correct prediction; and
output coordinates of each bounding box, class labels of objects in each bounding box, and the confidence score for each bounding box.

12. The system of claim 11, further comprising a server computer configured to:
train the CNN object detection model by augmenting original training data including core images of siliciclastic sedimentary rocks to expand object bounding boxes threefold by applying adjustments to brightness, exposure, and blur;
segment one of the core images into a grid of image cells; and
extract from each image cell of the grid, using the backbone CNN, image features at a plurality of different scales.

13. The system of claim 11, wherein the mobile device further configured to:
acquire the digital image of the siliciclastic sedimentary rock in the drilling core obtained by drilling into a subterranean geologic formation,
wherein to accurately distinguish between structural features of the siliciclastic sedimentary rock, the mobile device uses a cross-bedding angle threshold to differentiate between different types of stratified structures, where the stratified structures are layers of strata.

14. The system of claim 12, wherein the server computer is further configured to:
perform transfer learning, by the server computer, that utilizes weights from the CNN object detection model applied to a collection of annotated images obtained from various initial datasets and fine-tunes the CNN object detection model using annotated images from a second dataset.

15. The system of claim 12, wherein the server computer is further configured to:
in order to train the CNN object detection model using data with unbalanced classes, exclude classes with fewer than a predetermined number of bounding boxes, with an exception of a fissile shale.

16. The system of claim 12, wherein the server computer is further configured to:
apply a Non-Maximum Suppression (NMS) to filter out overlapping bounding boxes, and retain those non-overlapping bounding boxes with a highest confidence score.

17. The system of claim 14, wherein the second dataset includes box core images that present a fluvial, a shoreface, and a delta deposition with various lithologies, and wherein the transfer learning includes fine-tuning the CNN object detection model using the annotated images from the box core images that present the fluvial, the shoreface, and the delta deposition with the various lithologies.

18. The system of claim 12, wherein the server computer is further configured to train the CNN object detection model with a plurality of classes for different sedimentary structures and three background classes.

19. The system of claim 11, wherein the mobile device is further configured to display on a display screen of the mobile device, the digital image of the drilling core annotated with the bounding boxes, the class labels, and the confidence scores.

20. The system of claim 11, wherein the mobile device includes a user interface screen displayed on a display screen of the mobile device with an input class of the sedimentary structure, the system further comprising:
the mobile device configured to:
sequentially acquire a plurality of digital images of a plurality of drilling cores obtained while drilling into a subterranean geologic formation;
process a first digital image of the plurality of digital images by segmenting the first digital image into a grid of image cells;
extract from each image cell of the grid, using the backbone CNN, image features;
predict, by the CNN object detection model, multiple bounding boxes per grid cell, each bounding box having a confidence score that reflects the likelihood of an object's presence and a precision of a bounding box, wherein the precision of the bounding box is a percentage of the bounding box that is a correct prediction;
detect whether an object predicted by the CNN object detection model is greater than a predetermined confidence score for the input class;
output a notification that the input class has been detected in the first digital image of the drilling core when the input class has been detected; and
repeat the processing, the extracting, the predicting, the detecting, and the outputting steps for other digital images of the plurality of digital images.
